(19) United States
(12) Patent Application Publication
(10) Pub. No.: US 2026/0252057 A1
(43) Pub. Date: Aug. 27, 2026

(54) SYSTEM

(71) Applicant: SoftBank Group Corp., Tokyo (JP)

(72) Inventor: Kei IIJIMA, Tokyo (JP)

(73) Assignee: SoftBank Group Corp., Tokyo (JP)

(21) Appl. No.: 19/531,700

(22) Filed: Feb. 6, 2026

(30) Foreign Application Priority Data
Feb. 21, 2025 (JP) 2025-027009

(51) Int. Cl. G05B 19/4155; B25J 9/16; G06F 40/268; G06F 40/295; G06F 40/30

(52) U.S. Cl. CPC G05B 19/4155; B25J 9/1628; G06F 40/268; G06F 40/295; G06F 40/30; G05B 2219/32335

(57) ABSTRACT

The system according to the embodiment comprises a receiving unit, a generation unit, a manufacturing unit, and a delivery unit. The receiving unit is configured to receive a user's request. The generation unit is configured to create a product design drawing based on the request received by the receiving unit. The manufacturing unit is configured to manufacture a product based on the design drawing created by the generation unit. The delivery unit is configured to deliver the product manufactured by the manufacturing unit to an address specified by the user.

### CROSS-REFERENCE TO RELATED APPLICATION

The present application claims priority to and incorporates by reference the entire contents of Japanese Patent Application No. 2025-027009 filed in Japan on Feb. 21, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, there has been a problem that the process of designing, manufacturing, and delivering a product based on a user's request is not performed efficiently.

### SUMMARY OF THE INVENTION

The system according to the embodiment comprises a receiving unit, a generation unit, a manufacturing unit, and a delivery unit. The receiving unit is configured to receive a user's request. The generation unit is configured to create a product design drawing based on the request received by the receiving unit. The manufacturing unit is configured to manufacture a product based on the design drawing created by the generation unit. The delivery unit is configured to deliver the product manufactured by the manufacturing unit to an address specified by the user.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor denoted by a reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) denoted by a reference numeral is a memory where information is temporarily stored and used as a work memory by the processor.

In the following embodiments, a storage denoted by a reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) denoted by a reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

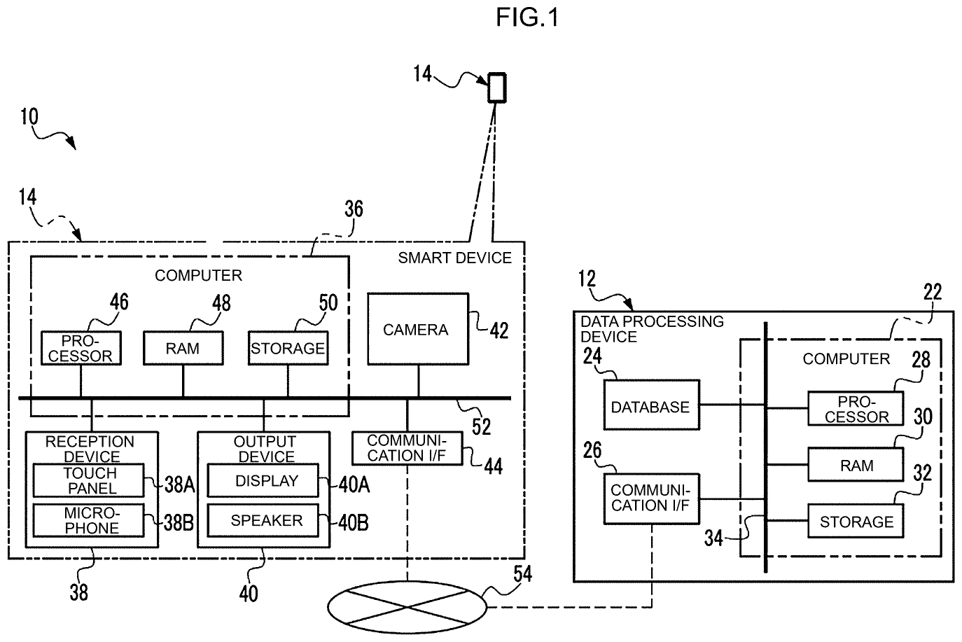

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

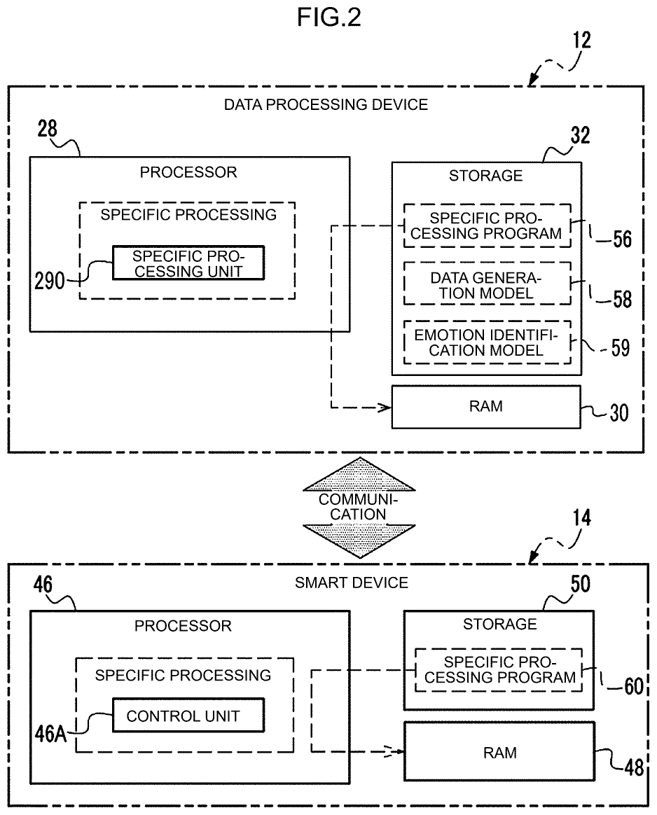

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example of the Embodiment

The system according to the embodiment of the present invention is a system in which a user requests product requirements in a chat format, a generative AI creates a design drawing, a manufacturing line automatically manufactures the product, and a delivery service delivers the product to the address specified by the user. This system begins when the user enters the requirements for the desired product into a chat box. For example, the user may input, “I want a wooden shelf with a height of 50 cm and a width of 30 cm.” This request is sent to the generative AI. The generative AI analyzes the request and creates a product design drawing. Based on the user's requirements, the generative AI specifically designs the dimensions, materials, and structure of the product. For example, the generative AI calculates the dimensions of the wooden shelf and determines the type of wood to be used and the assembly method. Next, a manufacturing line capable of handling the design drawing created by the generative AI is provided. The manufacturing line receives the information from the design drawing and automatically manufactures the product. The manufacturing line automatically performs processes such as cutting materials, assembling, and finishing. For example, the manufacturing line cuts the wood, assembles each part of the shelf, and performs finishing. Finally, the manufactured product is delivered to the address specified by the user. The manufactured product is delivered to the user's specified address by a delivery service. For example, the manufactured wooden shelf is delivered to the user's home. With this mechanism, the user can easily obtain a product that meets their requirements. Thus, the system can automate a series of processes for designing, manufacturing, and delivering a product based on the user's request. Specifically, the system receives text data input by the user into the chat box (e.g., natural language sentences such as “I want a wooden shelf with a height of 50 cm and a width of 30 cm”) via the receiving unit, performs morphological analysis and entity extraction as preprocessing, and converts it into a product specification vector (e.g., dimensions=[50, 30], material=wood, category=shelf). The system inputs this vectorized data into the generative AI. The generative AI, for example, uses a Transformer-based large language model, a conditional generative network (Conditional GAN), or a multimodal neural network to output product design drawing data (e.g., CAD data format, 3D model parameters, parts list, etc.) from the input vector. Examples of generative AI output include (1) a design specification document in JSON format describing dimensions, materials, and structure; (2) 3D CAD data (STL or STEP files); and (3) assembly instructions (text or image sequences). The system transfers the output from the generative AI to the manufacturing line control unit, which analyzes the design drawing data and generates a sequence of control commands for NC machine tools or industrial robots (e.g., G-code, robot arm operation sequences), and sequentially executes processes such as cutting materials, assembling parts, and surface finishing. The manufacturing line acquires sensor data (e.g., dimension sensors, image sensors) for each process, and a quality control AI detects errors and process anomalies in real time, automatically adjusting process parameters as necessary. After manufacturing is completed, the system sends shipping information (e.g., product ID, packaging status, shipping time) to the delivery management unit, which automatically determines the optimal delivery route and schedule by considering the user's specified address, desired time slot, and delivery means (courier, drone, etc.). The delivery unit tracks the delivery status in real time and sends progress notifications to the user. As a technical effect, the system automates the entire process from inputting requirements in natural language by the user to product design, manufacturing, and delivery, thereby achieving significant improvements in processing speed, reduction of human errors, increased personalization accuracy, and shortened manufacturing and delivery lead times compared to conventional manual design, manufacturing instructions, and delivery arrangements. Furthermore, the system enables complex optimization processes that are difficult with conventional rule-based or human heuristics, such as design optimization in high-dimensional feature space by AI, real-time quality control, and dynamic delivery route optimization. Specific application fields include custom furniture manufacturing, made-to-order production, on-demand manufacturing, personalized gifts, and smart logistics, and future expansion to IoT integration and automatic optimization of the entire supply chain is possible.

The system according to the embodiment comprises a receiving unit, a generation unit, a manufacturing unit, and a delivery unit. The receiving unit is configured to receive requests input by the user into a chat box. The requests input by the user into the chat box may include, for example, product type, specifications, quantity, etc., but are not limited thereto. The receiving unit can receive requests in various formats, such as text input, voice input, and real-time response. The generation unit uses generative AI to create a product design drawing based on the request received by the receiving unit. The generative AI, for example, uses technologies such as deep learning and neural networks to specifically design the dimensions, materials, and structure of the product based on the user's request. The generation unit, for example, analyzes the user's request using generative AI, calculates the product dimensions, and determines the materials to be used and the assembly method. The manufacturing unit automatically performs processes of cutting materials, assembling, and finishing based on the design drawing created by the generative AI. The manufacturing unit, for example, automates the product manufacturing process according to the machines used, work procedures, and quality standards. The manufacturing unit manufactures the product using, for example, machines for cutting materials, robots for assembling parts, and devices for finishing. The delivery unit delivers the manufactured product to the address specified by the user. The delivery unit uses means such as courier service, mail, or drone delivery to deliver the product to the address specified by the user. Thus, the system according to the embodiment can automate a series of processes for designing, manufacturing, and delivering a product based on the user's request. Specifically, the system first receives request data from the user (e.g., natural language text such as “I want a wooden shelf with a height of 50 cm and a width of 30 cm,” voice data, real-time chat logs, etc.) via the receiving unit, and converts it into a product specification vector (e.g., dimensions=[50, 30], material=wood, category=shelf, quantity=1) using morphological analysis and entity extraction algorithms (e.g., BERT-based named entity extraction model, speech recognition engine). The system transfers these vectorized data to the generation unit, which utilizes a large language model based on Transformer architecture, conditional generative networks, or multimodal neural networks to generate product design drawing data (e.g., 3D CAD data, parts list, assembly instructions, etc.) from the input vector. Examples of input to the AI include (1) text-based specification vectors (dimensions, material, category), (2) text data after speech recognition, and (3) image or sketch data. Examples of AI output include (1) a JSON design specification document describing dimensions, materials, and structure, (2) 3D CAD data (STL files), and (3) assembly instructions (text or image sequences). The generation unit transfers the output design drawing data to the manufacturing unit, which generates a sequence of commands (e.g., G-code, robot arm operation sequences) for controlling NC machine tools or industrial robots, and sequentially and automatically executes processes such as cutting materials, assembling parts, and surface finishing. The manufacturing unit acquires sensor data (e.g., dimension sensors, image sensors) for each process, and a quality control AI detects errors and process anomalies in real time, automatically adjusting process parameters as necessary. After manufacturing is completed, the manufacturing unit sends shipping information (e.g., product ID, packaging status, shipping time) to the delivery unit, which automatically determines the optimal delivery route and schedule by considering the user's specified address, desired time slot, and delivery means (courier, drone, etc.). The delivery unit tracks the delivery status in real time and sends progress notifications to the user. As a technical effect, the system automates the entire process from inputting requirements in natural language or voice by the user to product design, manufacturing, and delivery, thereby achieving significant improvements in processing speed, reduction of human errors, increased personalization accuracy, and shortened manufacturing and delivery lead times compared to conventional manual design, manufacturing instructions, and delivery arrangements. Furthermore, the system enables complex optimization processes that are difficult with conventional rule-based or human heuristics, such as design optimization in high-dimensional feature space by AI, real-time quality control, and dynamic delivery route optimization. Specific application fields include custom furniture manufacturing, made-to-order production, on-demand manufacturing, personalized gifts, and smart logistics, and future expansion to IoT integration and automatic optimization of the entire supply chain is possible.

The receiving unit is capable of receiving requests input by the user into a chat box. The chat box may include formats such as text input, voice input, and real-time response, but is not limited thereto. The receiving unit, for example, receives requests input by the user into the chat box. For example, the user may input “I want a wooden shelf with a height of 50 cm and a width of 30 cm.” The receiving unit sends this request to the generative AI. By receiving requests input by the user into the chat box, the user's requirements can be accurately understood. Specifically, the receiving unit receives natural language text or voice data input by the user, and in the case of voice input, converts it into text data using a speech recognition engine (e.g., deep neural network-based speech recognition model). The receiving unit performs morphological analysis and named entity extraction (e.g., BERT or CRF-based entity extraction) on the converted text data to generate a product specification vector (e.g., dimensions=[50,30], material=wood, category=shelf). The receiving unit transfers these vectorized data to the generation unit. Examples of input to the AI include (1) natural language text such as “I want a wooden shelf with a height of 50 cm and a width of 30 cm,” (2) voice input such as “I want to make a wooden shelf with a height of 50 cm and a width of 30 cm,” and (3) sequential addition of requirements in real-time chat. Examples of AI output include (1) product specification vectors (dimensions, material, category), (2) structured lists of user requirements, and (3) warnings of missing requirements. The receiving unit sends these outputs to the generation unit for subsequent design AI processing. As a technical effect, the receiving unit can handle various input formats and convert ambiguous user requirements such as natural language and voice into structured data with high accuracy, thereby greatly improving the accuracy and processing speed of receiving requests compared to conventional simple form input or manual interviews. Application fields include custom product ordering, smart home appliance control, and personalized service reception.

The generation unit is capable of specifically designing the dimensions, materials, and structure of a product based on the user's request using generative AI. The generative AI, for example, uses technologies such as deep learning and neural networks to specifically design the dimensions, materials, and structure of the product based on the user's request. The generation unit, for example, analyzes the user's request using generative AI, calculates the product dimensions, and determines the materials to be used and the assembly method. For example, based on a request such as “I want a wooden shelf with a height of 50 cm and a width of 30 cm,” the generative AI calculates the dimensions of the wooden shelf and determines the type of wood to be used and the assembly method. Thus, the generative AI can perform detailed design of the product based on the user's request. Specifically, the generation unit inputs the product specification vector received from the receiving unit (e.g., dimensions=, material=wood, category=shelf) into a Transformer-based large language model or conditional generative network. Examples of input to the AI include (1) numerical and categorical vectors consisting of dimensions, material, and category; (2) extended vectors including additional requirements (e.g., load capacity 10 kg, color=natural); and (3) multidimensional tensors with the user's past design history added. The generative AI outputs (1) a JSON design specification document describing dimensions, materials, and structure; (2) 3D CAD data (STL or STEP files); and (3) assembly instructions (text or image sequences). For example, the output JSON design specification document may include details such as “height: 50 cm, width: 30 cm, material: wood, number of shelves: 3, assembly method: screw fastening.” The generation unit transfers the output data to the manufacturing unit for use in automating the manufacturing process. As a technical effect, the generation unit achieves design optimization in high-dimensional feature space, improved design accuracy for user requirements, and faster design work. Compared to conventional manual or rule-based design, it can flexibly handle complex requirements and personalization demands. Application fields include custom furniture design, made-to-order production, and on-demand manufacturing.

The manufacturing unit is capable of automatically performing processes of cutting materials, assembling, and finishing based on the design drawing created by the generative AI. The manufacturing unit, for example, automates the product manufacturing process according to the machines used, work procedures, and quality standards. The manufacturing unit manufactures the product using, for example, machines for cutting materials, robots for assembling parts, and devices for finishing. For example, the manufacturing unit cuts the wood, assembles each part of the shelf, and performs finishing. Thus, the manufacturing process can be automated based on the design drawing created by the generative AI. Specifically, the manufacturing unit analyzes the design drawing data (e.g., 3D CAD data, parts list, assembly instructions) received from the generation unit and automatically generates a sequence of control commands (e.g., G-code, robot arm operation sequences) for NC machine tools or industrial robots. The manufacturing unit acquires sensor data (e.g., dimension sensors, image sensors, torque sensors) in real time for each process, and a quality control AI determines error detection and process anomalies. Examples of input to the AI include (1) design drawing data (CAD files), (2) parts list (JSON format), and (3) assembly instructions (text or image sequences). Examples of AI output include (1) G-code for NC machines, (2) robot arm operation sequences, and (3) quality judgment scores (pass/fail, error value). The manufacturing unit automatically adjusts process parameters (cutting speed, assembly torque, etc.) based on the quality judgment score and issues alerts or rework instructions in case of anomalies. As a technical effect, the manufacturing unit automates the entire process from design drawing to manufacturing, achieving reduction of human errors, improved manufacturing accuracy, faster processing, and real-time quality control. Application fields include smart factories, custom product manufacturing, and unmanned manufacturing lines.

The delivery unit is capable of delivering the manufactured product to the address specified by the user. The delivery unit uses means such as courier service, mail, or drone delivery to deliver the product to the address specified by the user. For example, the delivery unit delivers the manufactured wooden shelf to the user's home. By delivering the manufactured product to the address specified by the user, user convenience can be improved. Specifically, the delivery unit uses shipping information received from the manufacturing unit (e.g., product ID, packaging status, shipping time, delivery address) and determines the optimal delivery means and route using delivery means selection AI and route optimization algorithms. Examples of input to the AI include (1) delivery address, desired time slot, product size, weight; (2) candidate delivery means (courier, drone, motorcycle courier); and (3) traffic conditions and weather data. Examples of AI output include (1) optimal delivery means (e.g., drone delivery), (2) delivery route (map route), and (3) delivery schedule (estimated arrival time, intermediate stops). The delivery unit tracks the delivery status in real time and sends progress notifications (e.g., delivery started, estimated arrival, delivery completed) to the user. As a technical effect, the delivery unit achieves shortened delivery lead time, cost reduction, and improved user convenience through automatic selection of delivery means and route optimization. Application fields include smart logistics, on-demand delivery, and last-mile delivery.

The receiving unit is capable of estimating the user's emotion and adjusting the timing of receiving the request based on the estimated emotion of the user. For example, if the user is feeling stressed, the receiving unit quickly receives the request to reduce the user's burden. If the user is relaxed, the receiving unit receives the request at a normal pace, allowing time to confirm detailed requirements. Furthermore, if the user is in a hurry, the receiving unit prioritizes receiving the request and quickly proceeds to the next step. By adjusting the timing of receiving the request according to the user's emotion, the user's burden can be reduced. Emotion estimation is realized using, for example, an emotion engine or generative AI with emotion estimation functionality. The generative AI may be a text generative AI (e.g., LLM) or a multimodal generative AI, but is not limited thereto. Specifically, the receiving unit receives natural language text, voice data, or real-time chat logs input by the user into the chat box, applies preprocessing such as tokenization or spectral transformation in the preprocessing unit, and inputs the data into an emotion estimation AI. Examples of input to the AI include (1) natural language text indicating urgency, such as “I want to order now, I'm in a hurry,” (2) voice data with a fast tone or speaking rate, and (3) time-series emotion score arrays extracted from chat history. The emotion estimation AI uses, for example, a Transformer-based large language model, speech emotion recognition CNN, or multimodal fusion network to output emotion labels (e.g., stress, relaxation, urgency), emotion intensity scores (e.g., 0.85/1.0), and time-series emotion change vectors from the input data. Examples of output include (1) probability distributions such as “stress: 0.92, relaxation: 0.08,” (2) “urgent” labels, and (3) time-series transitions such as “emotion change: stress→relaxation.” The receiving unit evaluates these output values in a threshold judgment unit, and if stress or urgency is high, immediately executes the request receiving process; if relaxation is high, sets a waiting time for additional questions or confirmation of detailed requirements, dynamically adjusting the timing of receiving requests. Furthermore, the receiving unit can accumulate the user's emotion estimation results as logs and use them for future personalization of receiving algorithms and continuous learning of AI models. As a technical effect, the receiving unit can estimate the user's emotional state with high accuracy and in real time, and optimize the timing of receiving requests based on the results, thereby improving user experience, speeding up reception processing, reducing stress, and lowering dropout rates compared to conventional uniform reception or manual handling. In addition, emotion estimation and dynamic timing control in high-dimensional feature space by AI enable complex reception optimization that is difficult with human heuristics or simple rule-based approaches. Specific application fields include custom product order reception, call center automatic response, stress care reception in medical and welfare fields, and smart home appliance control interfaces. Furthermore, the receiving unit can switch the architecture and parameters of the emotion estimation AI (e.g., BERT-based emotion classification layer, speech feature extraction CNN layer, multimodal fusion layer) according to the application and user attributes, and further improvement in emotion estimation accuracy is expected in the future through integration with biosensors and wearable devices.

The receiving unit is capable of analyzing the user's past request history and selecting an appropriate receiving method. For example, the receiving unit automatically displays as candidates the requirements for products that the user has frequently requested in the past. The receiving unit can also preferentially propose the request method (chat, voice, etc.) that the user has used in the past. Furthermore, the receiving unit can predict and propose the request method used at specific times based on the user's past request history. By analyzing the user's past request history, the optimal receiving method can be selected. Specifically, the receiving unit maintains a request history database for each user, accumulated in chronological order (e.g., structured data including request content, reception date and time, input means, product category, response history, etc.), and inputs these history data as input feature vectors (e.g., categorical variables, time encoding, input means one-hot vectors, etc.) into an AI model. Examples of input to the AI include (1) history records such as “2024-05-01 19:00 chat furniture shelf height 50 cm,” (2) various history data such as “2024-05-03 08:30 voice home appliance air purifier,” and (3) request frequency distributions or time-of-day histograms for each user. The receiving unit inputs these data into a recurrent neural network (RNN), time-series clustering algorithm, or Transformer-based history analysis model, and outputs (1) a list of recommended product candidates for the next request (e.g., “wooden shelf,” “air purifier,” etc.), (2) recommended receiving means (e.g., “voice input,” “chat input,” etc.), and (3) recommended receiving timing (e.g., “weekday evenings,” “weekend mornings,” etc.). Examples of output include “Next time, a chat request for the furniture category is expected,” “Voice input is preferentially displayed because it was selected three times in a row,” etc. The receiving unit automatically displays candidate products and receiving means on the user interface based on these AI outputs, minimizing user selection operations. Furthermore, the receiving unit monitors the confidence scores of AI outputs and changes in history patterns, and automatically switches receiving methods or asks additional questions when thresholds are exceeded. As a technical effect, the receiving unit analyzes history patterns for each user in high-dimensional feature space, greatly improving the personalization accuracy and speed of receiving methods compared to conventional simple history reference or manual selection of receiving means. In addition, AI-based history analysis contributes to early detection of user behavior changes and new needs, enabling continuous optimization of the reception experience. Specific application fields include custom product order reception, smart home appliance control, personalized service reception, and individual response reception in medical and welfare fields, and future expansion to automatic optimization of IoT device integration and multi-channel reception is possible.

The receiving unit is capable of performing filtering at the time of receiving a request based on the user's current project or field of interest. For example, the receiving unit preferentially receives requirements for products related to the user's ongoing project. The receiving unit can also filter and display requirements for products related to the user's field of interest. Furthermore, the receiving unit can receive requests based on product categories that the user has shown interest in in the past. By filtering requests based on the user's current project or field of interest, highly relevant requests can be preferentially received. Specifically, the receiving unit maintains a project management database for each user (e.g., project ID, progress status, related product categories, planned start/end dates, etc.) and a field of interest profile (e.g., past browsing history, click history, survey responses, etc.), and inputs this information as feature vectors (e.g., categorical encoding, TF-IDF vectors, time-series progress scores, etc.) into an AI model. Examples of input to the AI include (1) project information such as “Project A: furniture category, in progress, due date 2024-06-01,” (2) user profile such as “field of interest: smart home appliances, eco products,” and (3) history data such as “request category distribution for the past 30 days.” The receiving unit inputs these data into a multilayer perceptron, graph neural network, or recommendation model with attention mechanism, and outputs (1) a list of candidate product requirements related to the current project, (2) a priority display list of product categories matching the field of interest, and (3) a reception priority score (e.g., 0.92/1.0). Examples of output include “Priority display of requirements for shelves, desks, and chairs related to the ongoing furniture project,” “Filtering requests for eco home appliance categories to the top,” etc. The receiving unit automatically displays highly relevant product requirements on the user interface based on these AI outputs, reducing the user's selection burden. Furthermore, the receiving unit monitors changes in project progress and field of interest in real time, and dynamically updates the AI model's continuous learning and filtering criteria. As a technical effect, the receiving unit analyzes the user's project progress and field of interest in high-dimensional feature space, greatly improving the relevance and personalization accuracy of reception compared to conventional static category selection or manual setting of reception priority. In addition, dynamic filtering by AI enables prompt response to changes in user needs and the occurrence of new projects, simultaneously optimizing the reception experience and operational efficiency. Specific application fields include B2B custom product ordering, project-based service reception, personalized settings for smart home appliances and IoT devices, and individual task reception in education and research fields.

The receiving unit is capable of estimating the user's emotion and determining the priority of requests to be received based on the estimated emotion of the user. For example, if the user is feeling stressed, the receiving unit sets a high priority for the request and responds quickly. If the user is relaxed, the receiving unit sets the priority as usual. Furthermore, if the user is in a hurry, the receiving unit sets the priority to the highest and responds immediately. By determining the priority of requests according to the user's emotion, rapid and appropriate response is possible. Emotion estimation is realized using, for example, an emotion engine or generative AI with emotion estimation functionality. The generative AI may be a text generative AI (e.g., LLM) or a multimodal generative AI, but is not limited thereto. Specifically, the receiving unit receives natural language text, voice data, or real-time chat logs input by the user into the chat box, applies preprocessing such as tokenization or spectral transformation in the preprocessing unit, and inputs the data into an emotion estimation AI. Examples of input to the AI include (1) natural language text indicating urgency, such as “I want to order now, I'm in a hurry,” (2) voice data with a fast tone or speaking rate, and (3) time-series emotion score arrays extracted from chat history. The emotion estimation AI uses, for example, a Transformer-based large language model, speech emotion recognition CNN, or multimodal fusion network to output emotion labels (e.g., stress, relaxation, urgency), emotion intensity scores (e.g., 0.85/1.0), and time-series emotion change vectors from the input data. Examples of output include (1) probability distributions such as “stress: 0.92, relaxation: 0.08,” (2) “urgent” labels, and (3) time-series transitions such as “emotion change: stress→relaxation.” The receiving unit evaluates these output values in a threshold judgment unit, and if stress or urgency is high, immediately executes the request receiving process; if relaxation is high, sets a waiting time for additional questions or confirmation of detailed requirements, dynamically adjusting the timing and priority of receiving requests. Furthermore, the receiving unit can accumulate the user's emotion estimation results as logs and use them for future personalization of receiving algorithms and continuous learning of AI models. As a technical effect, the receiving unit can estimate the user's emotional state with high accuracy and in real time, and optimize the priority of reception based on the results, thereby improving user experience, speeding up reception processing, reducing stress, and lowering dropout rates compared to conventional uniform reception or manual handling. In addition, emotion estimation and dynamic priority control in high-dimensional feature space by AI enable complex reception optimization that is difficult with human heuristics or simple rule-based approaches. Specific application fields include custom product order reception, call center automatic response, stress care reception in medical and welfare fields, and smart home appliance control interfaces. Furthermore, the receiving unit can switch the architecture and parameters of the emotion estimation AI (e.g., BERT-based emotion classification layer, speech feature extraction CNN layer, multimodal fusion layer) according to the application and user attributes, and further improvement in emotion estimation accuracy is expected in the future through integration with biosensors and wearable devices.

The summary generation unit is capable of generating a summary that captures the emotional nuances of an answer and reflecting emotional elements in the evaluation. For example, when the generative AI performs summarization, the summary generation unit captures the emotional nuances of the answer. The summary generation unit may generate a summary based on emotion scores. The summary generation unit may also construct a system in which the generative AI reflects the emotional elements of the answer in the evaluation. For example, the summary generation unit may perform evaluation based on emotion scores. The summary generation unit may also develop an algorithm for the generative AI to generate a summary that captures the emotional nuances of the answer. For example, the summary generation unit generates a summary based on emotion scores and reflects it in the evaluation. By generating a summary that captures emotional nuances, emotional elements can also be reflected in the evaluation. Emotion estimation is realized using, for example, an emotion engine or generative AI with emotion estimation functionality. The generative AI may be a text generative AI (e.g., LLM) or a multimodal generative AI, but is not limited thereto. Furthermore, the summary generation unit may combine multiple emotion estimation techniques to capture emotional nuances. For example, the summary generation unit may combine technologies such as facial expression recognition, voice analysis, and text analysis to more accurately capture emotional nuances. The summary generation unit may also construct a feedback loop for reflecting emotional elements in the evaluation. For example, the summary generation unit evaluates the emotional elements of the generated summary and updates the emotion estimation algorithm based on the evaluation results. Thus, the summary generation unit can always provide summaries that capture emotional nuances based on the latest emotion estimation technology. Furthermore, the summary generation unit is equipped with a function to visually display emotional elements. For example, the summary generation unit displays emotion scores as graphs or charts, providing them in an easy-to-understand visual format. The summary generation unit may also provide feedback pointing out areas for improvement in the answer based on emotional elements. For example, the summary generation unit identifies parts where emotional nuance is lacking or excessive and presents specific points for improvement. Thus, the summary generation unit not only provides summaries that capture emotional nuances but also provides feedback to improve the quality of the answer. Specifically, the summary generation unit receives answer text data (e.g., natural language sentences such as “I felt very frustrated while working on this assignment”) as input, the preprocessing unit performs tokenization and context feature extraction, and inputs the data into an emotion estimation AI. Examples of input to the AI include (1) natural language text of the answer body, (2) voice feature vectors after spectral transformation in the case of voice answers, and (3) facial image data at the time of answer creation. The emotion estimation AI combines a Transformer-based large language model, speech emotion recognition CNN, and convolutional neural network for facial expression recognition, and outputs emotion labels (e.g., joy, sadness, anger, surprise), emotion intensity scores (e.g., 0.78/1.0), and time-series emotion change vectors from the input data. Examples of output include (1) probability distributions such as “sadness: 0.65, anger: 0.20, joy: 0.15,” (2) time-series transitions such as “emotion change: sadness→joy,” and (3) surprise score of 0.82 detected from facial images. The summary generation unit inputs these emotion estimation results into a summary generation AI (e.g., LLM or multimodal generative model) and generates a summary sentence reflecting emotional nuances (e.g., “This answer strongly expresses frustration and motivation to take on challenges”). Furthermore, the summary generation unit displays the summary sentence and emotion scores as graphs, providing visual feedback to evaluators and users. The summary generation unit transfers the generated summary and emotion scores to an evaluation AI, which outputs a comprehensive evaluation score for the answer (e.g., logic 7.5/10, emotional expression 8.2/10) and a list of improvement points (e.g., “emotional expression is somewhat excessive, reinforce logical development”). The summary generation unit uses the evaluation results as a feedback loop to update the parameters of the emotion estimation AI and summary generation AI, aiming for continuous improvement in accuracy. As a technical effect, the summary generation unit links multiple modal emotion estimation technologies and summary generation AI, achieving high-precision extraction and evaluation reflection of emotional nuances, automation of summary generation, and continuous improvement in accuracy through feedback, compared to conventional simple summary generation or manual emotion evaluation. In addition, visualization of emotion scores and presentation of improvement points contribute to promoting understanding and improving quality for answer creators and evaluators. Specific application fields include automatic answer evaluation in education, customer support summaries with emotion analysis, patient record summarization in medical and welfare fields, and emotional expression evaluation in creative writing, with future expansion to biosensor integration and real-time emotion feedback possible.

The receiving unit is capable of analyzing the user's social media activity at the time of receiving a request and receiving relevant requests. For example, the receiving unit preferentially receives requests related to products mentioned by the user on social media. The receiving unit can also identify product categories of interest from the user's social media activity and receive requests. Furthermore, the receiving unit can receive requests related to brands or products followed by the user on social media. By analyzing the user's social media activity, relevant requests can be preferentially received. Specifically, the receiving unit acquires the user's public social media post data (e.g., post text, images, videos, follow list, like history, etc.) via API, performs natural language processing and image feature extraction in the preprocessing unit, and generates feature vectors (e.g., post content TF-IDF vectors, image embedding vectors, brand ID one-hot vectors, etc.). Examples of input to the AI include (1) post text such as “Recently interested in ○○ product,” (2) follow history of official brand accounts, and (3) like history for product images. The receiving unit inputs these feature vectors into a multilayer perceptron, graph neural network, or Transformer-based recommendation AI, and outputs (1) a list of related product categories (e.g., “home appliances,” “furniture,” etc.), (2) a list of product candidates to be preferentially received (e.g., “air purifier,” “wooden shelf,” etc.), and (3) a reception priority score (e.g., 0.91/1.0). Examples of output include “Priority reception of new product requests for recently followed brands,” “Top display of categories with high mention frequency in the past week,” etc. The receiving unit automatically displays highly relevant product request candidates on the user interface based on these AI outputs, reducing the user's selection burden. Furthermore, the receiving unit monitors changes in social media activity in real time and dynamically updates the AI model's continuous learning and reception priority. As a technical effect, the receiving unit analyzes the user's social media activity in high-dimensional feature space, greatly improving the relevance and personalization accuracy of reception compared to conventional static category selection or manual setting of reception priority. In addition, dynamic filtering by AI enables prompt response to changes in user interests and discovery of new brands, simultaneously optimizing the reception experience and operational efficiency. Specific application fields include B2C custom product ordering, personalized recommendation-type EC reception, brand marketing-linked reception, and automatic reception for smart home appliances and IoT devices, with future expansion to multi-channel integration and real-time trend analysis possible.

The generation unit is capable of estimating the user's emotion and adjusting the expression method of the design drawing based on the estimated emotion of the user. For example, if the user is relaxed, the generation unit generates a detailed design drawing and provides it to the user. If the user is in a hurry, the generation unit generates a concise design drawing and provides it quickly. Furthermore, if the user is excited, the generation unit generates a visually attractive design drawing and provides it to the user. By adjusting the expression method of the design drawing according to the user's emotion, the generation unit can provide a design drawing that is easy for the user to understand. Emotion estimation is realized using, for example, an emotion engine or generative AI with emotion estimation functionality. The generative AI may be a text generative AI (e.g., LLM) or a multimodal generative AI, but is not limited thereto. Specifically, the generation unit tokenizes or performs spectral transformation on the user's natural language text, voice data, or real-time chat logs received from the receiving unit in the preprocessing unit, and inputs the data into an emotion estimation AI (e.g., Transformer-based large language model, speech emotion recognition CNN, multimodal fusion network). Examples of input to the AI include (1) natural language text such as “I'm in a hurry, a simple design drawing is fine,” (2) voice data with a fast speaking rate or tone, and (3) time-series emotion score arrays extracted from chat history. The emotion estimation AI outputs emotion labels (e.g., relaxation, urgency, excitement), emotion intensity scores (e.g., 0.85/1.0), and time-series emotion change vectors from the input data. Examples of output include probability distributions such as “urgency: 0.92, relaxation: 0.08,” “excitement” labels, and time-series transitions such as “emotion change: urgency →relaxation.” The generation unit inputs these emotion estimation results into a design drawing generation AI (e.g., LLM or multimodal generative model) and dynamically adjusts the expression method of the design drawing (level of detail, length of explanation, color scheme, layout, etc.) according to the emotional state. For example, if urgency is high, a concise design drawing with only key points is generated; if relaxation is high, a detailed design drawing including dimensions and assembly instructions is generated; if excitement is high, a design drawing with colorful colors or animations is generated. The generation unit provides the generated design drawing to the user to improve understanding and satisfaction. As a technical effect, the generation unit can estimate the user's emotional state with high accuracy and in real time, and optimize the design drawing expression based on the results, thereby improving user experience, design drawing comprehension, and reducing dropout rates compared to conventional uniform design drawing generation or manual handling. In addition, emotion estimation and dynamic expression control in high-dimensional feature space by AI enable complex design drawing optimization that is difficult with human heuristics or simple rule-based approaches. Specific application fields include custom product design, presentation of design drawings in education, smart home appliance control interfaces, and personalized design support, with future expansion to biosensor integration and real-time emotion feedback possible.

The generation unit is capable of adjusting the specific level of detail of the design drawing at the time of generating the design drawing based on the importance of the product. For example, for products of high importance, the generation unit generates a detailed design drawing to support precise manufacturing. For products of low importance, the generation unit generates a concise design drawing to support rapid manufacturing. Furthermore, the generation unit can adjust the level of detail of the design drawing stepwise according to the importance of the product. By adjusting the level of detail of the design drawing according to the importance of the product, the efficiency of the manufacturing process can be improved. Specifically, the generation unit receives a product specification vector from the receiving unit (e.g., a multidimensional vector including dimensions, material, category, importance score, etc.), assigns an importance score (e.g., a continuous value such as 0.95/1.0 or a categorical value such as “high,” “medium,” “low”) to the design drawing generation AI, and uses a Transformer-based large language model, conditional generative network, or multimodal neural network to automatically determine design drawing generation parameters (e.g., level of detail, amount of annotation, dimensional accuracy, degree of parts breakdown) by combining the input vector and importance score. Examples of input to the AI include (1) a vector with dimensions, material, category, and importance=high, (2) a simplified product specification vector with importance=low, and (3) a product specification vector with an intermediate importance score of 0.7. Examples of AI output include (1) a JSON design specification document with detailed dimensions, materials, and assembly instructions (high importance), (2) a simplified design drawing listing only main dimensions and parts list (low importance), and (3) annotated 3D CAD data with moderate detail (medium importance). The generation unit dynamically adjusts the granularity and amount of annotation of the design drawing data transferred to the manufacturing unit according to the level of detail parameter in the AI output. In subsequent processing, the manufacturing unit switches the control command generation algorithm for NC machine tools or industrial robots according to the level of detail of the received design drawing, optimizing processes such as precision machining or simple assembly. As a technical effect, the generation unit automatically adjusts the level of detail of the design drawing according to the importance of the product, thereby achieving process efficiency, optimal resource allocation, manufacturing cost reduction, and shortened delivery times compared to conventional uniform design drawing generation or manual adjustment of detail level. In addition, optimization of detail level in high-dimensional feature space by AI enables complex design drawing generation control that is difficult with human heuristics or simple rule-based approaches. Specific application fields include precision manufacturing of important parts, mass production of consumables, stepwise design support for custom products, and automatic optimization of B2B/B2C manufacturing lines, with future expansion to IoT integration and control of design drawing granularity across the entire supply chain possible.

The generation unit is capable of applying an appropriate design algorithm at the time of generating the design drawing according to the category of the product. For example, for products in the furniture category, the generation unit applies a design algorithm that considers the characteristics of wood. For products in the electronic device category, the generation unit applies a design algorithm specialized for circuit design. Furthermore, for products in the clothing category, the generation unit applies a design algorithm that considers the characteristics of fabric. By applying an appropriate design algorithm according to the category of the product, the accuracy of the design can be improved. Specifically, the generation unit receives a product specification vector from the receiving unit (e.g., a multidimensional vector including category=furniture/electronic device/clothing, dimensions, material, usage, etc.), and inputs the category information into a design algorithm selection AI (e.g., a multitask neural network with a category classification layer and an algorithm selection layer). Examples of input to the AI include (1) category=furniture, material=wood, dimensions=[50, 30]; (2) category=electronic device, board size=[100, 80], circuit requirements=5V/2 A; and (3) category=clothing, fabric=cotton, size=M. The AI automatically selects the optimal design algorithm module from multiple design algorithm modules according to the input category, such as (1) 3D structure optimization algorithm considering wood strength and joint characteristics, (2) circuit layout and wiring optimization algorithm for circuit design, and (3) clothing design algorithm considering fabric elasticity and sewing patterns, and passes parameters to the design drawing generation AI. Examples of AI output include (1) furniture design drawing with wood joint strength calculation, (2) electronic device design drawing including circuit diagram and parts layout diagram, and (3) clothing design drawing with sewing line instructions. By applying different design algorithms for each category, the generation unit greatly improves design accuracy and manufacturing suitability. In subsequent processing, the manufacturing unit automatically selects different manufacturing processes for each category (e.g., woodworking, board mounting, sewing line) and generates control commands optimized for the design drawing. As a technical effect, the generation unit achieves significant improvements in design accuracy, manufacturing suitability, and process efficiency by automatically applying design algorithms according to product category, compared to conventional general-purpose design or manual selection of algorithms. In addition, AI-based category recognition and algorithm switching can flexibly handle complex product groups and small-lot multi-variety production. Specific application fields include custom design of furniture, home appliances, and clothing, multi-category manufacturing lines, and design automation platforms, with future expansion to automatic learning of new categories and design algorithms possible.

The generation unit is capable of estimating the user's emotion and adjusting the length of the design drawing based on the estimated emotion of the user. For example, if the user is in a hurry, the generation unit generates a short design drawing that covers the main points. If the user is relaxed, the generation unit generates a longer design drawing with detailed explanations. Furthermore, if the user is excited, the generation unit generates a design drawing with visually stimulating effects. By adjusting the length of the design drawing according to the user's emotion, the generation unit can provide a design drawing that meets the user's needs. Emotion estimation is realized using, for example, an emotion engine or generative AI with emotion estimation functionality. The generative AI may be a text generative AI (e.g., LLM) or a multimodal generative AI, but is not limited thereto. Specifically, the generation unit tokenizes or performs spectral transformation on the user's natural language text, voice data, or real-time chat logs received from the receiving unit in the preprocessing unit, and inputs the data into an emotion estimation AI (e.g., Transformer-based large language model, speech emotion recognition CNN, multimodal fusion network). Examples of input to the AI include (1) natural language text such as “I'm in a hurry, a simple design drawing is fine,” (2) voice data with a fast speaking rate or tone, and (3) time-series emotion score arrays extracted from chat history. The emotion estimation AI outputs emotion labels (e.g., urgency, relaxation, excitement), emotion intensity scores (e.g., 0.85/1.0), and time-series emotion change vectors from the input data. Examples of output include probability distributions such as “urgency: 0.92, relaxation: 0.08,” “excitement” labels, and time-series transitions such as “emotion change: urgency→relaxation.” The generation unit inputs these emotion estimation results into a design drawing generation AI (e.g., LLM or multimodal generative model) and dynamically adjusts the length of the design drawing (amount of explanation, presence of annotations, level of detail in drawings, presence of effects, etc.) according to the emotional state. For example, if urgency is high, a short design drawing with only key points is generated; if relaxation is high, a long design drawing including detailed dimensions and assembly instructions is generated; if excitement is high, a design drawing with colorful colors or animations is generated. The generation unit provides the generated design drawing to the user to improve understanding and satisfaction. In subsequent processing, the manufacturing unit adjusts automation parameters for the manufacturing process (e.g., number of process divisions, annotation display, granularity of work instructions) according to the length and level of detail of the design drawing. As a technical effect, the generation unit can estimate the user's emotional state with high accuracy and in real time, and optimize the length of the design drawing based on the results, thereby improving user experience, design drawing comprehension, and reducing dropout rates compared to conventional uniform design drawing generation or manual handling. In addition, emotion estimation and dynamic length control in high-dimensional feature space by AI enable complex design drawing optimization that is difficult with human heuristics or simple rule-based approaches. Specific application fields include custom product design, presentation of design drawings in education, smart home appliance control interfaces, and personalized design support, with future expansion to biosensor integration and real-time emotion feedback possible.

The generation unit is capable of determining the specific priority of the design drawing at the time of generating the design drawing based on the submission timing of the product. For example, for products with an imminent submission deadline, the generation unit prioritizes the generation of the design drawing. For products with ample time before submission, the generation unit generates the design drawing with normal priority. Furthermore, the generation unit can adjust the design drawing generation schedule based on the submission timing. By determining the priority of the design drawing based on the submission timing of the product, the generation unit can generate design drawings in accordance with delivery deadlines. Specifically, the generation unit adds submission timing information (e.g., delivery date and time, remaining days, priority score, etc.) to the product specification vector received from the receiving unit and inputs it into a scheduling AI (e.g., time-series prediction model or priority optimization algorithm). Examples of input to the AI include (1) product specification vector with delivery date=2024-06-01, remaining days=2, priority=high; (2) product specification vector with delivery date=2024-07-15, remaining days=30, priority=low; and (3) a list of delivery dates and priorities for multiple products. The AI automatically determines the design drawing generation order and schedule (e.g., immediate generation, normal generation, delayed generation) based on the input delivery date information and priority score, and instructs the design drawing generation AI. Examples of AI output include (1) generation order list such as “Generate design drawing for Product A with highest priority,” “Product B on normal schedule,” (2) scheduled start and end times for design drawing generation, and (3) design drawing generation queue with priority scores. The generation unit dynamically schedules the design drawing generation process according to the AI output, minimizing the risk of delivery delays. In subsequent processing, the manufacturing unit and delivery unit automatically adjust manufacturing and delivery plans in conjunction with the design drawing generation schedule. As a technical effect, the generation unit achieves improved delivery compliance rate, elimination of process bottlenecks, and maximization of overall throughput by automatically optimizing the priority of design drawing generation based on submission timing, compared to conventional manual scheduling or uniform processing. In addition, time-series prediction and priority optimization by AI can flexibly handle simultaneous progress of multiple product types and sudden changes in delivery dates. Specific application fields include made-to-order manufacturing, project-based design work, process management in smart factories, and delivery deadline optimization for B2B/B2C, with future expansion to delivery-linked design across the entire supply chain possible.

The generation unit is capable of adjusting the specific order of the design drawing at the time of generating the design drawing based on the relevance of the product. For example, for highly relevant products, the generation unit prioritizes the generation of the design drawing. For products with low relevance, the generation unit generates the design drawing in the normal order. Furthermore, the generation unit can adjust the generation order of the design drawing based on the relevance of the product. By adjusting the order of the design drawing based on the relevance of the product, efficient generation of design drawings is possible. Specifically, the generation unit calculates a relevance score (e.g., within the same project, part commonality, usage similarity, user-specified group, etc.) for multiple product specification vectors received from the receiving unit and inputs them into a relevance clustering AI (e.g., graph neural network or clustering algorithm). Examples of input to the AI include (1) multiple product specification vectors within Project A, (2) product pairs with part commonality of 0.8, and (3) product lists with usage similarity scores. The AI analyzes the relevance between products in high-dimensional feature space and outputs (1) design drawing generation order list for each relevance cluster, (2) instructions for prior generation of common part design drawings, and (3) design drawing generation queue with relevance scores. The generation unit prioritizes the generation of design drawings for highly relevant products according to the AI output, reducing duplication of design work and improving process efficiency. In subsequent processing, the manufacturing unit automates batch manufacturing of common parts and simultaneous execution of processes for related products, improving overall manufacturing efficiency. As a technical effect, the generation unit achieves process efficiency, shortened lead times, and cost reduction by automatically optimizing the generation order of design drawings based on product relevance, compared to conventional individual design or manual order determination. In addition, relevance analysis by AI can flexibly handle complex projects and small-lot multi-variety production. Specific application fields include project-based product design, module commonization design, BOM optimization, and process coordination in smart factories, with future expansion to relevance-linked design across the entire supply chain possible.

The manufacturing unit is capable of estimating the user's emotion and adjusting the method of the manufacturing process based on the estimated emotion of the user. For example, if the user is relaxed, the manufacturing unit applies the standard manufacturing process. If the user is in a hurry, the manufacturing unit applies a method for rapid execution of the manufacturing process. Furthermore, if the user is excited, the manufacturing unit adds visual effects to the manufacturing process. By adjusting the method of the manufacturing process according to the user's emotion, the manufacturing unit can manufacture products that meet the user's needs. Emotion estimation is realized using, for example, an emotion engine or generative AI with emotion estimation functionality. The generative AI may be a text generative AI (e.g., LLM) or a multimodal generative AI, but is not limited thereto. Specifically, the manufacturing unit tokenizes or performs spectral transformation on the user's natural language text (e.g., “I'm in a hurry, please manufacture as quickly as possible”), voice data (e.g., voice with fast speaking rate or tone), real-time chat logs, or past emotion history received from the receiving unit in the preprocessing unit, and inputs the data into an emotion estimation AI (e.g., Transformer-based large language model, speech emotion recognition CNN, multimodal fusion network). Examples of input to the AI include (1) natural language text indicating urgency, such as “I'm in a hurry, please finish quickly,” (2) voice data with a fast tone or speaking rate, and (3) time-series emotion score arrays extracted from chat history. The emotion estimation AI outputs emotion labels (e.g., relaxation, urgency, excitement), emotion intensity scores (e.g., 0.85/1.0), and time-series emotion change vectors from the input data. Examples of output include probability distributions such as “urgency: 0.92, relaxation: 0.08,” “excitement” labels, and time-series transitions such as “emotion change: urgency→relaxation.” The manufacturing unit inputs these emotion estimation results into a manufacturing process control AI (e.g., process parameter optimization model, process scheduler, effect generation module) and dynamically adjusts the method of the manufacturing process (process order, work speed, quality control granularity, presence of visual effects, etc.) according to the emotional state. For example, if urgency is high, parallelization of processes or priority scheduling is applied; if relaxation is high, the standard process flow is maintained; if excitement is high, animations or colorful effects are added to the monitor screen or progress notifications in the manufacturing site. The manufacturing unit acquires sensor data (e.g., dimension sensors, image sensors, torque sensors) at each stage of the manufacturing process, and a quality control AI determines error detection and process anomalies, automatically adjusting process parameters as necessary. In subsequent processing, the manufacturing unit sends progress status and product completion notifications to the user after manufacturing is completed, improving user experience. As a technical effect, the manufacturing unit can estimate the user's emotional state with high accuracy and in real time, and optimize the method of the manufacturing process based on the results, thereby improving user experience, shortening manufacturing lead time, improving process efficiency, and increasing product satisfaction compared to conventional uniform manufacturing or manual handling. In addition, emotion estimation and dynamic process control in high-dimensional feature space by AI enable complex manufacturing optimization that is difficult with human heuristics or simple rule-based approaches. Specific application fields include custom product manufacturing, smart factories, personalized manufacturing lines, and manufacturing sites with entertainment features, with future expansion to biosensor integration and further automatic optimization of manufacturing sites through real-time emotion feedback possible.

The manufacturing unit is capable of estimating the user's emotion and adjusting the method of the manufacturing process based on the estimated emotion of the user. For example, if the user is relaxed, the manufacturing unit applies the standard manufacturing process. If the user is in a hurry, the manufacturing unit can apply a method to expedite the manufacturing process. Furthermore, if the user is excited, the manufacturing unit can add visual effects to the manufacturing process. By adjusting the method of the manufacturing process according to the user's emotion, it is possible to manufacture products that meet the user's needs. Emotion estimation is realized by using an emotion estimation function, for example, with an emotion engine or generative AI. Generative AI may include text generation AI (e.g., LLM) or multimodal generative AI, but is not limited thereto. Specifically, the manufacturing unit tokenizes or performs spectral conversion on the user's natural language text received from the receiving unit (e.g., “I'm in a hurry, please manufacture as quickly as possible”), voice data (e.g., fast speech rate or tone), real-time chat logs, or the user's past emotion history in a preprocessing unit, and inputs them into an emotion estimation AI (e.g., Transformer-based large language model, speech emotion recognition CNN, multimodal fusion network). Examples of input to the AI include: (1) natural language text indicating urgency such as “I'm in a hurry, please finish quickly”; (2) voice data with fast tone or speech rate; (3) time-series emotion score arrays extracted from chat history. The emotion estimation AI outputs emotion labels (e.g., relaxed, urgent, excited), emotion intensity scores (e.g., 0.85/1.0), and time-series emotion change vectors from the input data. Examples of output include probability distributions such as “urgent: 0.92, relaxed: 0.08”, an “excited” label, and time-series transitions such as “emotion change: urgent→relaxed”. The manufacturing unit inputs these emotion estimation results into a manufacturing process control AI (e.g., process parameter optimization model, process scheduler, effect generation module) and dynamically adjusts the method of the manufacturing process (process order, work speed, quality control granularity, presence or absence of visual effects, etc.) according to the emotional state. For example, if urgency is high, parallelization of processes or priority scheduling is applied; if relaxation is high, the standard process flow is maintained; if excitement is high, animations or colorful effects are added to the monitor screens or progress notifications at the manufacturing site. The manufacturing unit acquires sensor data (e.g., dimension sensors, image sensors, torque sensors) at each stage of the manufacturing process, and a quality control AI detects errors or process anomalies and automatically adjusts process parameters as necessary. As a subsequent process, after manufacturing is completed, the manufacturing unit sends progress status and product completion notifications to the user to enhance the user experience. As a technical effect, the manufacturing unit can estimate the user's emotional state with high accuracy and in real time, and optimize the manufacturing process method based on the result, thereby achieving improvements in user experience, reduction of manufacturing lead time, process efficiency, and product satisfaction compared to conventional uniform manufacturing or manual handling. In addition, emotion estimation in high-dimensional feature space and dynamic process control by AI enable complex manufacturing optimization that is difficult with human heuristics or simple rule-based approaches. Specific application fields include custom product manufacturing, smart factories, personalized manufacturing lines, and manufacturing sites with entertainment features, and future developments may include further automatic optimization of manufacturing sites through integration with biosensors and real-time emotion feedback.

The manufacturing unit is capable of analyzing the user's past product manufacturing history during manufacturing and selecting an appropriate manufacturing method. For example, the manufacturing unit selects the optimal manufacturing method based on data of products previously manufactured by the user. The manufacturing unit can also identify points for improvement in the manufacturing process from the user's past product manufacturing history and select the optimal method. Furthermore, the manufacturing unit can analyze the user's past product manufacturing history and select an efficient manufacturing method. By analyzing the user's past product manufacturing history, it is possible to select the optimal manufacturing method. Specifically, the manufacturing unit maintains a product manufacturing history database accumulated in chronological order for each user (e.g., structured data including product ID, manufacturing date and time, materials used, manufacturing process, quality score, required manufacturing time, user evaluation, etc.), and inputs these history data as feature vectors (e.g., categorical variables, time encoding, process parameter vectors, etc.) into an AI model. Examples of input to the AI include: (1) history records such as “2024-05-01 shelf wood cutting-assembly-finishing required time 2 h quality 9.2”; (2) diverse history data such as “2024-05-03 desk metal assembly-painting required time 3 h quality 8.8”; (3) manufacturing process frequency distributions and quality histograms for each user. The manufacturing unit inputs these into a recurrent neural network (RNN), time-series clustering algorithm, or Transformer-based history analysis model, and generates as output: (1) recommended manufacturing process sequence for the next manufacturing (e.g., “cutting-assembly-finishing”); (2) recommended materials and machine settings (e.g., “wood A, cutting speed 120 mm/s”); (3) list of process improvement points (e.g., “increase assembly process torque by 10%”). Examples of output include “cutting speed for wood was delayed three consecutive times, so speed is automatically adjusted” and “retraining is performed for processes with decreased quality scores”. The manufacturing unit automatically optimizes the manufacturing process and adjusts parameters based on these AI outputs, applying manufacturing methods optimized for each user. Furthermore, the manufacturing unit monitors the confidence scores of AI outputs and changes in history patterns, and when thresholds are exceeded, automatically switches manufacturing methods or proposes additional processes. As a technical effect, the manufacturing unit analyzes history patterns for each user in high-dimensional feature space, and can greatly improve the personalization accuracy, manufacturing speed, and quality of manufacturing methods compared to conventional simple history reference or manual selection of manufacturing methods. In addition, AI-based history analysis contributes to early detection of behavioral changes and new needs of users, enabling continuous optimization of the manufacturing experience. Specific application fields include custom product manufacturing, smart factories, personalized manufacturing lines, and individualized manufacturing in medical and welfare fields, and future developments may include automatic optimization through IoT device integration and multi-channel manufacturing.

The manufacturing unit is capable of specifically customizing the manufacturing process during manufacturing based on the user's current living situation. For example, if the user is busy, the manufacturing unit applies a method to expedite the manufacturing process. If the user is relaxed, the manufacturing unit can apply the standard manufacturing process. Furthermore, the manufacturing unit can adjust the schedule of the manufacturing process based on the user's living situation. By customizing the manufacturing process based on the user's current living situation, it is possible to manufacture products that meet the user's needs. Specifically, the manufacturing unit extracts features from the user's living situation data (e.g., calendar schedules, at-home/out-of-home status, work concentration level, health status, IoT appliance operation logs, etc.) obtained from the receiving unit or external collaboration modules in a preprocessing unit, and generates a living situation vector (e.g., busyness score 0.92, at-home rate 0.7, health level 0.85, etc.). Examples of input to the AI include: (1) calendar information such as “many meetings this week, busy”; (2) at-home/out-of-home logs from IoT sensors; (3) stress and health scores from wearable devices. The manufacturing unit inputs these living situation vectors into a multilayer perceptron, time-series prediction model, or multimodal fusion AI, and generates as output: (1) manufacturing process schedule (e.g., nighttime priority, weekend concentration); (2) process speed parameters (e.g., 120% faster than normal); (3) user notification timing (e.g., progress notifications limited to lunch break). Examples of output include “manufacturing is concentrated at night this week due to busyness” and “progress notifications are reduced due to declining health status”. The manufacturing unit dynamically adjusts manufacturing process scheduling, work speed, and notification timing based on AI output, providing a manufacturing experience that considers the user's life rhythm and burden. Furthermore, the manufacturing unit monitors changes in living situation in real time and performs continuous learning of the AI model and dynamic updating of process parameters. As a technical effect, the manufacturing unit analyzes the user's living situation in high-dimensional feature space, and can greatly improve the personalization accuracy and process efficiency of the manufacturing experience compared to conventional static process scheduling or manual adjustment. In addition, dynamic customization by AI enables prompt response to changes in the user's life or sudden schedule changes, simultaneously achieving optimization of the manufacturing experience and operational efficiency. Specific application fields include B2C custom product manufacturing, personalized home appliance manufacturing, life-linked process management in smart factories, and individualized manufacturing in medical and welfare fields, and future developments may include automatic optimization through IoT integration and multi-channel manufacturing.

The manufacturing unit is capable of estimating the user's emotion and determining the priority of the manufacturing process based on the estimated emotion of the user. For example, if the user is in a hurry, the manufacturing unit sets a high priority for the manufacturing process and responds quickly. If the user is relaxed, the manufacturing unit can set the priority of the manufacturing process as usual. Furthermore, if the user is excited, the manufacturing unit can adjust the priority of the manufacturing process and add visual effects. By determining the priority of the manufacturing process according to the user's emotion, rapid and appropriate response is possible. Emotion estimation is realized by using an emotion estimation function, for example, with an emotion engine or generative AI. Generative AI may include text generation AI (e.g., LLM) or multimodal generative AI, but is not limited thereto. Specifically, the manufacturing unit tokenizes or performs spectral conversion on the user's natural language text received from the receiving unit (e.g., “I'm in a hurry, please manufacture as quickly as possible”), voice data (e.g., fast speech rate or tone), real-time chat logs, or the user's past emotion history in a preprocessing unit, and inputs them into an emotion estimation AI (e.g., Transformer-based large language model, speech emotion recognition CNN, multimodal fusion network). Examples of input to the AI include: (1) natural language text indicating urgency such as “I'm in a hurry, please finish quickly”; (2) voice data with fast tone or speech rate; (3) time-series emotion score arrays extracted from chat history. The emotion estimation AI outputs emotion labels (e.g., urgent, relaxed, excited), emotion intensity scores (e.g., 0.85/1.0), and time-series emotion change vectors from the input data. Examples of output include probability distributions such as “urgent: 0.92, relaxed: 0.08”, an “excited” label, and time-series transitions such as “emotion change: urgent→relaxed”. The manufacturing unit inputs these emotion estimation results into a process priority determination AI (e.g., priority optimization algorithm, process scheduler) and dynamically adjusts the priority of the manufacturing process (e.g., immediate execution, normal execution, delayed execution) and progress notification method (e.g., real-time notification, periodic notification, notification with effects) according to the emotional state. For example, if urgency is high, the manufacturing process is scheduled with the highest priority; if relaxation is high, the process proceeds with normal priority; if excitement is high, animations or colorful effects are added to progress notifications. As a subsequent process, the manufacturing unit switches control command generation algorithms for NC machine tools or industrial robots according to the priority of the manufacturing process, and optimizes process parallelization and buffering. As a technical effect, the manufacturing unit can estimate the user's emotional state with high accuracy and in real time, and optimize the priority of the manufacturing process based on the result, thereby achieving improvements in user experience, reduction of manufacturing lead time, process efficiency, and product satisfaction compared to conventional uniform process progression or manual handling. In addition, emotion estimation in high-dimensional feature space and dynamic priority control by AI enable complex manufacturing optimization that is difficult with human heuristics or simple rule-based approaches. Specific application fields include custom product manufacturing, smart factories, personalized manufacturing lines, and manufacturing sites with entertainment features, and future developments may include further automatic optimization of manufacturing sites through integration with biosensors and real-time emotion feedback.

The manufacturing unit is capable of selecting an appropriate manufacturing method during manufacturing by considering the user's geographic location information. For example, the manufacturing unit selects the optimal manufacturing site based on the user's geographic location information. The manufacturing unit can also adjust the schedule of the manufacturing process by considering the user's geographic location information. Furthermore, the manufacturing unit can optimize the manufacturing process based on the user's geographic location information. By considering the user's geographic location information, it is possible to select the optimal manufacturing method. Specifically, the manufacturing unit extracts features from the user's geographic location information (e.g., latitude and longitude, city name, country, time zone, climate classification, etc.) obtained from the receiving unit or external collaboration modules in a preprocessing unit, and generates a location information vector (e.g., latitude=35.6, longitude=139.7, time zone=JST, climate=temperate). Examples of input to the AI include: (1) location information such as “Tokyo, latitude 35.6, longitude 139.7”; (2) list of manufacturing sites within a 50 km radius of the user's location; (3) environmental information such as “climate classification: temperate, high humidity”. The manufacturing unit inputs these location information vectors into a multilayer perceptron, graph neural network, or route optimization AI, and generates as output: (1) optimal manufacturing site selection (e.g., “Site A has the shortest delivery time”); (2) manufacturing process schedule (e.g., “operate at night according to local time”); (3) process parameters considering climate and logistics conditions (e.g., “add humidity control process”). Examples of output include “start manufacturing at the factory closest to the user's location” and “add drying process according to climate conditions”. The manufacturing unit dynamically adjusts manufacturing sites, process schedules, and process content based on AI output, providing a manufacturing experience optimized for the user's geographic conditions and logistics efficiency. Furthermore, the manufacturing unit monitors changes in geographic location information and logistics status in real time and performs continuous learning of the AI model and dynamic updating of process parameters. As a technical effect, the manufacturing unit analyzes the user's geographic location information in high-dimensional feature space, and can greatly improve the personalization accuracy and process efficiency of the manufacturing experience compared to conventional static site selection or manual process adjustment. In addition, dynamic optimization by AI enables prompt response to user movement or addition of new sites, simultaneously achieving optimization of the manufacturing experience and operational efficiency. Specific application fields include global B2C custom product manufacturing, regionally optimized smart factories, climate-linked manufacturing process management, and supply chain optimization, and future developments may include automatic optimization through IoT integration and multi-site manufacturing.

The manufacturing unit is capable of analyzing the user's social media activity during manufacturing and specifically proposing manufacturing processes. For example, the manufacturing unit identifies product categories of interest from the user's social media activity and proposes manufacturing processes. The manufacturing unit can also propose manufacturing processes related to products mentioned by the user on social media. Furthermore, the manufacturing unit can analyze the user's social media activity and propose optimal manufacturing methods. By analyzing the user's social media activity, it is possible to propose optimal manufacturing processes. Specifically, the manufacturing unit obtains the user's public social media post data (e.g., post text, images, videos, follow list, like history, etc.) via API, performs natural language processing and image feature extraction in a preprocessing unit, and generates feature vectors (e.g., post content TF-IDF vector, image embedding vector, brand ID one-hot vector, etc.). Examples of input to the AI include: (1) post text such as “I'm interested in ○○ products recently”; (2) follow history of official brand accounts; (3) like history for product images. The manufacturing unit inputs these feature vectors into a multilayer perceptron, graph neural network, or Transformer-based recommendation AI, and generates as output: (1) list of related product categories (e.g., “home appliances”, “furniture”, etc.); (2) candidate products to be prioritized for manufacturing (e.g., “air purifier”, “wooden shelf”, etc.); (3) list of proposed manufacturing processes (e.g., “strengthen assembly process”, “add painting process”). Examples of output include “prioritize manufacturing of new products from brands recently followed” and “strengthen processes for categories with high mention frequency in the past week”. The manufacturing unit automatically displays highly relevant manufacturing processes and product candidates on the user interface based on these AI outputs, reducing the user's selection burden. Furthermore, the manufacturing unit monitors changes in social media activity in real time and performs continuous learning of the AI model and dynamic updating of manufacturing process proposals. As a technical effect, the manufacturing unit analyzes the user's social media activity in high-dimensional feature space, and can greatly improve the relevance and personalization accuracy of manufacturing process proposals compared to conventional static category selection or manual process proposals. In addition, dynamic filtering by AI enables prompt response to changes in user interests or discovery of new brands, simultaneously achieving optimization of the manufacturing experience and operational efficiency. Specific application fields include B2C custom product manufacturing, personalized recommendation-based manufacturing, brand marketing-linked manufacturing, and automatic process proposal in smart factories, and future developments may include multi-channel integration and real-time trend analysis.

The delivery unit is capable of estimating the user's emotion and adjusting the delivery method based on the estimated emotion of the user. For example, if the user is in a hurry, the delivery unit selects a rapid delivery method. If the user is relaxed, the delivery unit can select the standard delivery method. Furthermore, if the user is excited, the delivery unit can include a special message or gift with the delivery. By adjusting the delivery method according to the user's emotion, it is possible to provide delivery that meets the user's needs. Emotion estimation is realized by using an emotion estimation function, for example, with an emotion engine or generative AI. Generative AI may include text generation AI (e.g., LLM) or multimodal generative AI, but is not limited thereto. Specifically, the delivery unit tokenizes or performs spectral conversion on the user's natural language text received from the receiving unit or user interface (e.g., “I'm in a hurry, please deliver as quickly as possible”), voice data (e.g., fast speech rate or tone), real-time chat logs, or the user's past emotion history in a preprocessing unit, and inputs them into an emotion estimation AI (e.g., Transformer-based large language model, speech emotion recognition CNN, multimodal fusion network). Examples of input to the AI include: (1) natural language text indicating urgency such as “I want it delivered today”; (2) voice data with fast tone or speech rate; (3) time-series emotion score arrays extracted from chat history. The emotion estimation AI outputs emotion labels (e.g., urgent, relaxed, excited), emotion intensity scores (e.g., 0.91/1.0), and time-series emotion change vectors from the input data. Examples of output include probability distributions such as “urgent: 0.92, relaxed: 0.08”, an “excited” label, and time-series transitions such as “emotion change: urgent→relaxed”. The delivery unit inputs these emotion estimation results into a delivery means selection AI or delivery experience optimization module and dynamically adjusts the delivery method (e.g., same-day delivery, standard delivery, delivery with gift included, etc.) and delivery experience elements (e.g., special message generation, gift selection, progress notification method, etc.) according to the emotional state. For example, if urgency is high, drone delivery or same-day delivery services are preferentially selected; if relaxation is high, cost-efficient standard delivery is selected; if excitement is high, colorful designs or special message cards are automatically generated and included in the delivery package. The delivery unit tracks the delivery status in real time and sends progress notifications (e.g., concise notifications, detailed explanations, notifications with visual effects, etc.) according to the user's emotional state. As a subsequent process, after delivery is completed, the delivery unit accumulates the user's emotional reactions as feedback and utilizes them to improve the personalization accuracy of the AI model and delivery experience algorithms. As a technical effect, the delivery unit can estimate the user's emotional state with high accuracy and in real time, and optimize the delivery method and experience elements based on the result, thereby achieving improvements in user experience, delivery satisfaction, repeat rate, and reduction of delivery lead time compared to conventional uniform delivery or manual handling. In addition, emotion estimation in high-dimensional feature space and dynamic delivery control by AI enable complex delivery optimization that is difficult with human heuristics or simple rule-based approaches. Specific application fields include custom product delivery, gift delivery, personalized e-commerce delivery, and smart logistics, and future developments may include further automatic optimization of the delivery experience through integration with biosensors and real-time emotion feedback.

The delivery unit is capable of analyzing the user's past delivery history during delivery and selecting an appropriate delivery method. For example, the delivery unit selects the optimal delivery method based on delivery methods previously used by the user. The delivery unit can also select a rapid delivery method from the user's past delivery history. Furthermore, the delivery unit can analyze the user's past delivery history and select an efficient delivery method. By analyzing the user's past delivery history, it is possible to select the optimal delivery method. Specifically, the delivery unit maintains a delivery history database accumulated in chronological order for each user (e.g., structured data including delivery date and time, delivery means, arrival time, delivery address, delivery satisfaction, trouble history, etc.), and inputs these history data as feature vectors (e.g., categorical variables, time encoding, delivery means one-hot vector, satisfaction score, etc.) into an AI model. Examples of input to the AI include: (1) history records such as “2024-05-01 courier arrival 2 days satisfaction 9.2”; (2) diverse history data such as “2024-05-03 drone delivery arrival 1 day satisfaction 8.8”; (3) delivery means frequency distributions and arrival delay histograms for each user. The delivery unit inputs these into a recurrent neural network (RNN), time-series clustering algorithm, or Transformer-based history analysis model, and generates as output: (1) recommended delivery means for the next delivery (e.g., “drone delivery”, “courier”); (2) recommended delivery schedule (e.g., “weekday night”, “weekend morning”); (3) list of delivery method improvement points (e.g., “prioritize drone delivery due to frequent delays with courier”). Examples of output include “drone delivery was selected with high satisfaction three consecutive times, so it is prioritized” and “avoid time periods with frequent arrival delays”. The delivery unit automatically optimizes delivery means and schedules based on these AI outputs, applying delivery methods optimized for each user. Furthermore, the delivery unit monitors the confidence scores of AI outputs and changes in history patterns, and when thresholds are exceeded, automatically switches delivery methods or proposes additional options. As a technical effect, the delivery unit analyzes history patterns for each user in high-dimensional feature space, and can greatly improve the personalization accuracy, delivery speed, and satisfaction of delivery methods compared to conventional simple history reference or manual selection of delivery methods. In addition, AI-based history analysis contributes to early detection of behavioral changes and new needs of users, enabling continuous optimization of the delivery experience. Specific application fields include custom product delivery, smart logistics, personalized e-commerce delivery, and individualized delivery in medical and welfare fields, and future developments may include automatic optimization through IoT device integration and multi-channel delivery.

The delivery unit is capable of specifically customizing the delivery means during delivery based on the user's current living situation. For example, if the user is busy, the delivery unit selects a rapid delivery means. If the user is relaxed, the delivery unit can select the standard delivery means. Furthermore, the delivery unit can adjust the schedule of the delivery means based on the user's living situation. By customizing the delivery means based on the user's current living situation, it is possible to provide delivery that meets the user's needs. Specifically, the delivery unit extracts features from the user's living situation data (e.g., calendar schedules, at-home/out-of-home status, work concentration level, health status, IoT appliance operation logs, etc.) obtained from the receiving unit or external collaboration modules in a preprocessing unit, and generates a living situation vector (e.g., busyness score 0.92, at-home rate 0.7, health level 0.85, etc.). Examples of input to the AI include: (1) calendar information such as “many meetings this week, busy”; (2) at-home/out-of-home logs from IoT sensors; (3) stress and health scores from wearable devices. The delivery unit inputs these living situation vectors into a multilayer perceptron, time-series prediction model, or multimodal fusion AI, and generates as output: (1) delivery schedule (e.g., nighttime priority, weekend concentration); (2) delivery means parameters (e.g., 120% faster than normal); (3) user notification timing (e.g., progress notifications limited to lunch break). Examples of output include “delivery is concentrated at night this week due to busyness” and “progress notifications are reduced due to declining health status”. The delivery unit dynamically adjusts delivery scheduling, means selection, and notification timing based on AI output, providing a delivery experience that considers the user's life rhythm and burden. Furthermore, the delivery unit monitors changes in living situation in real time and performs continuous learning of the AI model and dynamic updating of delivery parameters. As a technical effect, the delivery unit analyzes the user's living situation in high-dimensional feature space, and can greatly improve the personalization accuracy and efficiency of the delivery experience compared to conventional static delivery scheduling or manual adjustment. In addition, dynamic customization by AI enables prompt response to changes in the user's life or sudden schedule changes, simultaneously achieving optimization of the delivery experience and operational efficiency. Specific application fields include B2C custom product delivery, personalized home appliance delivery, life-linked process management in smart logistics, and individualized delivery in medical and welfare fields, and future developments may include automatic optimization through IoT integration and multi-channel delivery.

The delivery unit is capable of estimating the user's emotion and determining the priority of delivery based on the estimated emotion of the user. For example, if the user is in a hurry, the delivery unit sets a high priority for delivery and responds quickly. If the user is relaxed, the delivery unit can set the priority of delivery as usual. Furthermore, if the user is excited, the delivery unit can adjust the priority of delivery and include a special message or gift. By determining the priority of delivery according to the user's emotion, rapid and appropriate response is possible. Emotion estimation is realized by using an emotion estimation function, for example, with an emotion engine or generative AI. Generative AI may include text generation AI (e.g., LLM) or multimodal generative AI, but is not limited thereto. Specifically, the delivery unit tokenizes or performs spectral conversion on the user's natural language text received from the receiving unit or user interface (e.g., “I'm in a hurry, please deliver as quickly as possible”), voice data (e.g., fast speech rate or tone), real-time chat logs, or the user's past emotion history in a preprocessing unit, and inputs them into an emotion estimation AI (e.g., Transformer-based large language model, speech emotion recognition CNN, multimodal fusion network). Examples of input to the AI include: (1) natural language text indicating urgency such as “I want it delivered today”; (2) voice data with fast tone or speech rate; (3) time-series emotion score arrays extracted from chat history. The emotion estimation AI outputs emotion labels (e.g., urgent, relaxed, excited), emotion intensity scores (e.g., 0.91/1.0), and time-series emotion change vectors from the input data. Examples of output include probability distributions such as “urgent: 0.92, relaxed: 0.08”, an “excited” label, and time-series transitions such as “emotion change: urgent→relaxed”. The delivery unit inputs these emotion estimation results into a delivery priority determination AI or delivery experience optimization module and dynamically adjusts the delivery priority (e.g., immediate execution, normal execution, delayed execution) and delivery experience elements (e.g., special message generation, gift inclusion, progress notification method, etc.) according to the emotional state. For example, if urgency is high, the delivery process is scheduled with the highest priority; if relaxation is high, delivery proceeds with normal priority; if excitement is high, animations or colorful effects are added to progress notifications or packages. As a subsequent process, the delivery unit switches delivery means and route optimization algorithms according to the delivery priority, and optimizes process parallelization and buffering. As a technical effect, the delivery unit can estimate the user's emotional state with high accuracy and in real time, and optimize the delivery priority based on the result, thereby achieving improvements in user experience, reduction of delivery lead time, process efficiency, and delivery satisfaction compared to conventional uniform delivery or manual handling. In addition, emotion estimation in high-dimensional feature space and dynamic priority control by AI enable complex delivery optimization that is difficult with human heuristics or simple rule-based approaches. Specific application fields include custom product delivery, smart logistics, personalized delivery lines, and delivery sites with entertainment features, and future developments may include further automatic optimization of delivery sites through integration with biosensors and real-time emotion feedback.

The delivery unit is capable of selecting an appropriate delivery method during delivery by considering the user's geographic location information. For example, the delivery unit selects the optimal delivery site based on the user's geographic location information. The delivery unit can also adjust the schedule of the delivery process by considering the user's geographic location information. Furthermore, the delivery unit can optimize the delivery process based on the user's geographic location information. By considering the user's geographic location information, it is possible to select the optimal delivery method. Specifically, the delivery unit extracts features from the user's geographic location information (e.g., latitude and longitude, city name, country, time zone, climate classification, etc.) obtained from the receiving unit or external collaboration modules in a preprocessing unit, and generates a location information vector (e.g., latitude=35.6, longitude=139.7, time zone=JST, climate=temperate). Examples of input to the AI include: (1) location information such as “Tokyo, latitude 35.6, longitude 139.7”; (2) list of delivery sites within a 50 km radius of the user's location; (3) environmental information such as “climate classification: temperate, high humidity”. The delivery unit inputs these location information vectors into a multilayer perceptron, graph neural network, or route optimization AI, and generates as output: (1) optimal delivery site selection (e.g., “Site A has the shortest delivery time”); (2) delivery process schedule (e.g., “nighttime delivery according to local time”); (3) delivery parameters considering climate and logistics conditions (e.g., “add humidity control packaging”). Examples of output include “start delivery from the warehouse closest to the user's location” and “change packaging method according to climate conditions”. The delivery unit dynamically adjusts delivery sites, schedules, and packaging content based on AI output, providing a delivery experience optimized for the user's geographic conditions and logistics efficiency. Furthermore, the delivery unit monitors changes in geographic location information and logistics status in real time and performs continuous learning of the AI model and dynamic updating of delivery parameters. As a technical effect, the delivery unit analyzes the user's geographic location information in high-dimensional feature space, and can greatly improve the personalization accuracy and efficiency of the delivery experience compared to conventional static site selection or manual process adjustment. In addition, dynamic optimization by AI enables prompt response to user movement or addition of new sites, simultaneously achieving optimization of the delivery experience and operational efficiency. Specific application fields include global B2C custom product delivery, regionally optimized smart logistics, climate-linked delivery process management, and supply chain optimization, and future developments may include automatic optimization through IoT integration and multi-site delivery.

The delivery unit is capable of analyzing the user's social media activity during delivery and specifically proposing delivery means. For example, the delivery unit identifies delivery methods of interest from the user's social media activity and proposes them. The delivery unit can also propose means related to delivery methods mentioned by the user on social media. Furthermore, the delivery unit can analyze the user's social media activity and propose optimal delivery methods. By analyzing the user's social media activity, it is possible to propose optimal delivery means. Specifically, the delivery unit obtains the user's public social media post data (e.g., post text, images, videos, follow list, like history, etc.) via API, performs natural language processing and image feature extraction in a preprocessing unit, and generates feature vectors (e.g., post content TF-IDF vector, image embedding vector, delivery means ID one-hot vector, etc.). Examples of input to the AI include: (1) post text such as “I'm interested in drone delivery recently”; (2) follow history of official delivery service accounts; (3) like history for delivery means images. The delivery unit inputs these feature vectors into a multilayer perceptron, graph neural network, or Transformer-based recommendation AI, and generates as output: (1) list of related delivery means (e.g., “drone delivery”, “motorbike courier”, etc.); (2) candidate delivery methods to be prioritized for proposal (e.g., “drone delivery”); (3) list of proposed delivery means (e.g., “recommend eco delivery”, “introduce new service”). Examples of output include “prioritize proposal of new means from delivery services recently followed” and “display delivery methods with high mention frequency in the past week at the top”. The delivery unit automatically displays highly relevant delivery means and service candidates on the user interface based on these AI outputs, reducing the user's selection burden. Furthermore, the delivery unit monitors changes in social media activity in real time and performs continuous learning of the AI model and dynamic updating of delivery means proposals. As a technical effect, the delivery unit analyzes the user's social media activity in high-dimensional feature space, and can greatly improve the relevance and personalization accuracy of delivery means proposals compared to conventional static delivery means selection or manual proposals. In addition, dynamic filtering by AI enables prompt response to changes in user interests or discovery of new delivery services, simultaneously achieving optimization of the delivery experience and operational efficiency. Specific application fields include B2C custom product delivery, personalized recommendation-based delivery, brand marketing-linked delivery, and automatic delivery means proposal in smart logistics, and future developments may include multi-channel integration and real-time trend analysis.

The system according to the embodiment is not limited to the examples described above, and various modifications are possible, for example, as follows. Specifically, the present system allows for diverse variations and extensions regarding the internal algorithms and data flows of each component such as the receiving unit, generation unit, manufacturing unit, and delivery unit, the architecture of AI models, input/output data formats, parameter optimization methods, user interface design, and the configuration of external collaboration modules. For example, the receiving unit can support multiple channels for receiving user requests, such as natural language text input, voice input, image upload, and IoT device-linked input. The generation unit can utilize a combination of design drawing generation AI, such as Transformer-based large language models, conditional generative networks, multimodal generative models, or graph neural networks. The manufacturing unit can collaborate with various manufacturing devices such as NC machine tools, industrial robots, 3D printers, and IoT sensor networks, and optimize the manufacturing process by combining multiple process control AI and quality control AI. The delivery unit can flexibly switch delivery means and experience elements according to user needs and geographic conditions, including courier services, drone delivery, autonomous vehicle delivery, locker pickup, and real-time tracking notifications. Furthermore, each unit can realize advanced personalization and automatic optimization by linking multiple AI modules such as user emotion estimation AI, history analysis AI, living situation estimation AI, geographic location optimization AI, and social media analysis AI. Input data to the AI may include various formats such as user natural language text, voice data, image data, time-series history vectors, living situation vectors, location information vectors, and social media feature vectors, and outputs may include product candidate lists, design drawing data, manufacturing process sequences, delivery means and schedules, progress notifications, and feedback proposals. These outputs are used for subsequent process control, user interface display, external system collaboration, and continuous learning of AI models. As a technical effect, the present system can greatly improve overall processing efficiency, personalization accuracy, user experience, and the level of business automation compared to conventional static system design or manual individual optimization, due to the flexible expandability of each component and the diverse combination of AI modules. Specific application fields include custom product design, manufacturing, and delivery platforms, smart factories, personalized e-commerce, individualized services in medical and welfare fields, and IoT-linked supply chain optimization, and future developments can easily include new AI technologies, addition of external data sources, multi-site collaboration, and real-time optimization.

The receiving unit is capable of referring to the user's past purchase history when receiving a user's request and proposing related products. For example, by proposing products similar to those previously purchased by the user, the receiving unit can expand the user's options. The receiving unit can also analyze preferences for specific brands or categories from the user's past purchase history and propose appropriate products. Furthermore, the receiving unit can provide special discounts or campaign information at the time of request reception based on the user's purchase history. By utilizing the user's past purchase history, more personalized proposals can be made. Specifically, the receiving unit maintains a purchase history database accumulated in chronological order for each user (e.g., structured data including purchase date and time, product ID, brand, category, price, quantity, purchase channel, satisfaction score, etc.), and inputs these history data as feature vectors (e.g., categorical variables, brand ID one-hot vector, time encoding, purchase frequency histogram, etc.) into an AI model. Examples of input to the AI include: (1) history records such as “2024-05-01 furniture shelf brand A price 15,000 yen”; (2) diverse purchase data such as “2024-05-03 home appliance air purifier brand B price 20,000 yen”; (3) brand preference distributions and category-wise purchase frequency vectors for each user. The receiving unit inputs these into a recurrent neural network (RNN), graph neural network, or Transformer-based recommendation AI, and generates as output: (1) list of recommended product candidates for the next purchase (e.g., “new shelf from brand A”, “air purifier from brand B”, etc.); (2) recommended brands and categories (e.g., “prioritize furniture category”); (3) personalized discount and campaign information (e.g., “10% off brand A products”). Examples of output include “prioritize new furniture proposals due to three consecutive purchases in the furniture category” and “display special discount for brand B due to high repeat rate”. The receiving unit automatically displays highly relevant product candidates and discount information on the user interface based on these AI outputs, maximizing user selection operations and purchase motivation. Furthermore, the receiving unit monitors the confidence scores of AI outputs and changes in history patterns, and when thresholds are exceeded, automatically switches proposal content or asks additional questions. As a technical effect, the receiving unit analyzes purchase history patterns for each user in high-dimensional feature space, and can greatly improve proposal accuracy, personalization, and promotional effectiveness compared to conventional simple history reference or manual product proposals. In addition, AI-based history analysis contributes to early detection of changes in user preferences and new needs, enabling continuous optimization of the reception experience and sales improvement. Specific application fields include personalized e-commerce reception, custom product ordering, brand marketing-linked reception, and automatic proposals for smart home appliances and IoT devices, and future developments may include multi-channel integration and real-time promotion optimization.

The generation unit is capable of creating design drawings based on the user's request while considering the user's past feedback. For example, the generation unit refers to feedback previously provided by the user and reflects improvements in the design. The generation unit can also analyze preferences for specific design elements from the user's feedback and reflect them in the design. Furthermore, the generation unit can adjust algorithms to improve design quality based on the user's feedback. By utilizing the user's past feedback, it is possible to provide more satisfactory designs. Specifically, the generation unit maintains a design feedback database accumulated in chronological order for each user (e.g., structured data including design drawing ID, feedback date and time, evaluation score, comments, improvement requests, design element-wise evaluation, satisfaction score, etc.), and inputs these feedback data as feature vectors (e.g., design element one-hot vector, time encoding, evaluation score distribution, etc.) into an AI model. Examples of input to the AI include: (1) feedback records such as “2024-05-01 design drawing A evaluation 8.5 comment: make the color brighter”; (2) diverse feedback data such as “2024-05-03 design drawing B evaluation 7.2 comment: make the size larger”; (3) design element preference distributions and evaluation score histograms for each user. The generation unit inputs these into a multilayer perceptron, graph neural network, or Transformer-based design optimization AI, and generates as output: (1) list of improvement points to be reflected in the next design (e.g., “make the color brighter”, “make the size larger”, etc.); (2) recommended design elements (e.g., “colorful color scheme”, “large size”); (3) design quality improvement parameters (e.g., “color emphasis 0.8”, “size magnification 1.2”). Examples of output include “prioritize bright color schemes due to three consecutive requests regarding color” and “propose larger size due to declining size evaluation”. The generation unit inputs these AI outputs into a design drawing generation AI (e.g., conditional generative network or multimodal generative model) and automatically generates design drawings reflecting the user's preferences and improvement requests. Furthermore, the generation unit monitors the confidence scores of AI outputs and changes in feedback patterns, and when thresholds are exceeded, automatically adjusts design algorithms or makes additional proposals. As a technical effect, the generation unit analyzes feedback patterns for each user in high-dimensional feature space, and can greatly improve design quality, personalization, and user satisfaction compared to conventional simple feedback reference or manual design improvement. In addition, AI-based feedback analysis contributes to early detection of changes in user preferences and new requests, enabling continuous optimization of the design experience. Specific application fields include custom product design, personalized design support, creative design automation, and individualized design in education and welfare fields, and future developments may include multimodal feedback and real-time design optimization.

The manufacturing unit is capable of monitoring product quality in real time during the manufacturing process and adjusting the manufacturing process as necessary. For example, during manufacturing, the manufacturing unit uses sensors to measure product dimensions and finish, and automatically makes adjustments if values deviate from standards. The manufacturing unit can also accumulate product quality data and optimize the manufacturing process based on past data. Furthermore, the manufacturing unit can perform regular maintenance and calibration to ensure product quality. By monitoring quality in real time during the manufacturing process, it is possible to always provide high-quality products. Specifically, the manufacturing unit obtains multidimensional sensor data in real time from various sensors placed on the manufacturing line (e.g., dimension sensors, image sensors, torque sensors, temperature sensors, etc.), normalizes and extracts features in a preprocessing unit, and inputs them into a quality monitoring AI (e.g., convolutional neural network for anomaly detection, time-series prediction model, image classification AI, etc.). Examples of input to the AI include: (1) dimension vectors such as “dimensions=[50.2, 29.8, 10.1 ]mm, tolerance ±0.2 mm”; (2) surface image tensors (256×256×3); (3) torque time series such as “[1.2, 1.3, 1.1, . . . ]Nm”. The quality monitoring AI outputs quality judgment labels (e.g., “pass”, “rework required”, “fail”), anomaly scores (e.g., 0.92/1.0), and anomaly location maps (e.g., coordinates of abnormal regions on images) from the input data. Examples of output include “dimension anomaly: rework required”, “surface scratch detected: fail”, “torque anomaly: readjustment”. The manufacturing unit transfers these AI outputs to a process control AI or manufacturing device control module, and if an anomaly is detected, automatically adjusts process parameters (e.g., cutting speed, assembly torque, temperature settings, etc.) and executes rework or process branching. Furthermore, the manufacturing unit accumulates all process quality judgment results and sensor data in a quality database in chronological order, extracts long-term quality trends and process improvement points using a history analysis AI (e.g., RNN or clustering model), and realizes continuous optimization of the manufacturing process and preventive maintenance scheduling (e.g., automatic proposal of maintenance timing, optimization of calibration frequency). As a technical effect, the manufacturing unit can greatly improve quality stability, defect rate reduction, process efficiency, and maintenance cost reduction compared to conventional manual inspection or static process control, through real-time quality monitoring and automatic process adjustment by AI. Specific application fields include precision parts manufacturing, smart factories, personalized manufacturing lines, medical device manufacturing, and IoT-linked quality management, and future developments may include multilayered anomaly detection AI and global quality monitoring through real-time cloud integration.

The delivery unit is capable of adjusting the delivery schedule according to the delivery time slot specified by the user during delivery. For example, if the user can only receive the delivery at a specific time slot, the delivery is made to match that time slot. The delivery unit can also notify the user in real time if there is a delay in the specified delivery time slot. Furthermore, the delivery unit can select the optimal delivery route according to the user's specified delivery time slot and perform efficient delivery. By flexibly responding to the user's specified delivery time slot, user convenience can be improved. Specifically, the delivery unit inputs delivery time slot data received from the user (e.g., time interval information such as “18:00-20:00”, “Saturday morning”) into a scheduling AI (e.g., time-series optimization model, route optimization algorithm, delivery resource allocation AI, etc.). Examples of input to the AI include: (1) delivery request such as “delivery request=2024-06-01 18:00-20:00, address=Tokyo”; (2) list of delivery time slots requested by multiple users; (3) real-time traffic information and delivery vehicle location data. The scheduling AI outputs optimal delivery schedules (e.g., “start delivery between 18:00-19:00”), delivery routes (e.g., “route A is shortest”), and delay prediction scores (e.g., 0.12/1.0) from the input data. Examples of output include “select route B to meet the requested time slot” and “notify user in advance due to delay prediction of 0.8”. The delivery unit automatically generates operation plans for delivery vehicles or drones based on these AI outputs and executes delivery according to the user's specified time slot. If a delay occurs, the delivery unit notifies the user in real time and automatically sends situation explanations or rescheduling proposals. Furthermore, the delivery unit accumulates delivery history and delay occurrence patterns in chronological order, and performs continuous learning of the AI model and dynamic updating of route optimization algorithms. As a technical effect, the delivery unit can greatly improve delivery convenience, punctuality rate, user satisfaction, and delivery efficiency compared to conventional static delivery or manual adjustment, through delivery scheduling based on user-specified time slots and route optimization by AI. Specific application fields include personalized e-commerce delivery, smart logistics, B2C/B2B deadline optimization, and time-specified delivery in medical and welfare fields, and future developments may include automatic optimization through real-time traffic integration and multimodal delivery.

The receiving unit is capable of estimating the user's emotion and customizing the receiving method of requests based on the estimated emotion of the user. For example, if the user is feeling stressed, the receiving unit accepts requests in a simple question format to reduce the user's burden. If the user is relaxed, the receiving unit can accept requests in a dialog format to confirm detailed requirements. Furthermore, if the user is excited, the receiving unit can accept requests using a visually attractive interface. By customizing the receiving method of requests according to the user's emotion, user satisfaction can be improved. Specifically, the receiving unit tokenizes or performs spectral conversion on the user's natural language text entered in the chat box, voice data, real-time chat logs, etc., in a preprocessing unit, and inputs them into an emotion estimation AI (e.g., Transformer-based large language model, speech emotion recognition CNN, multimodal fusion network). Examples of input to the AI include: (1) natural language text such as “I'm tired today, so I want to finish quickly”; (2) voice data with slow tone or speech rate; (3) time-series emotion score arrays extracted from chat history. The emotion estimation AI outputs emotion labels (e.g., stress, relaxation, excitement), emotion intensity scores (e.g., 0.85/1.0), and time-series emotion change vectors from the input data. Examples of output include probability distributions such as “stress: 0.92, relaxation: 0.08”, an “excited” label, and time-series transitions such as “emotion change: stress→relaxation”. The receiving unit inputs these emotion estimation results into a receiving method selection AI or user interface control module and dynamically adjusts the receiving method (e.g., simple question format, detailed dialog format, UI with visual effects), question granularity, and interface design according to the emotional state. For example, if stress is high, a simple UI centered on choices is automatically generated; if relaxation is high, a detailed requirements confirmation dialog is generated; if excitement is high, a colorful animated UI is generated. The receiving unit accumulates user reactions and satisfaction as feedback and utilizes them to improve the personalization accuracy of the AI model and receiving experience algorithms. As a technical effect, the receiving unit can estimate the user's emotional state with high accuracy and in real time, and optimize the receiving method based on the result, thereby achieving improvements in user experience, reduction of receiving burden, and reduction of dropout rate compared to conventional uniform reception or manual handling. In addition, emotion estimation in high-dimensional feature space and dynamic UI control by AI enable complex reception optimization that is difficult with human heuristics or simple rule-based approaches. Specific application fields include custom product order reception, call center automatic response, stress care-type reception in medical and welfare fields, and smart home appliance control interfaces, and future developments may include integration with biosensors and real-time emotion feedback.

The generation unit is capable of estimating the user's emotion and adjusting the style of the design drawing based on the estimated emotion of the user. For example, if the user is relaxed, the generation unit provides a simple and calm design drawing. If the user is excited, the generation unit can provide a colorful and visually stimulating design drawing. Furthermore, if the user is feeling stressed, the generation unit can provide an intuitive and easy-to-understand design drawing. By adjusting the style of the design drawing according to the user's emotion, it is possible to provide a design drawing that is easy to understand and attractive to the user. Specifically, the generation unit tokenizes or performs spectral conversion on the user's natural language text, voice data, or real-time chat logs received from the receiving unit in a preprocessing unit, and inputs them into an emotion estimation AI (e.g., Transformer-based large language model, speech emotion recognition CNN, multimodal fusion network). Examples of input to the AI include: (1) natural language text such as “I want a calm design today”; (2) voice data with gentle speech rate or tone; (3) time-series emotion score arrays extracted from chat history. The emotion estimation AI outputs emotion labels (e.g., relaxation, excitement, stress), emotion intensity scores (e.g., 0.85/1.0), and time-series emotion change vectors from the input data. Examples of output include probability distributions such as “relaxation: 0.92, excitement: 0.05, stress: 0.03”, an “excited” label, and time-series transitions such as “emotion change: relaxation→excitement”. The generation unit inputs these emotion estimation results into a design drawing generation AI (e.g., LLM or multimodal generative model) and dynamically adjusts the style of the design drawing (color scheme, layout, amount of annotation, intuitiveness of the drawing, etc.) according to the emotional state. For example, if relaxation is high, a pale color scheme and simple layout are generated; if excitement is high, a colorful color scheme and animated elements are generated; if stress is high, an intuitive design centered on icons and diagrams is automatically generated. The generation unit provides the generated design drawing to the user to improve understanding and satisfaction. Furthermore, the generation unit utilizes user reactions and feedback for continuous learning of the AI model and parameter updates of the design drawing style optimization algorithm. As a technical effect, the generation unit can estimate the user's emotional state with high accuracy and in real time, and optimize the style of the design drawing based on the result, thereby achieving improvements in user experience, understanding of the design drawing, and reduction of dropout rate compared to conventional uniform design drawing generation or manual handling. In addition, emotion estimation in high-dimensional feature space and dynamic style control by AI enable complex design drawing optimization that is difficult with human heuristics or simple rule-based approaches. Specific application fields include custom product design, presentation of design drawings in education, smart home appliance control interfaces, personalized design support, and future developments may include integration with biosensors and real-time emotion feedback.

The manufacturing unit is capable of estimating the user's emotion and notifying the progress of the manufacturing process based on the estimated emotion of the user. For example, if the user is in a hurry, the manufacturing unit notifies the progress of the manufacturing process in real time to provide reassurance to the user. If the user is relaxed, the manufacturing unit can notify the progress of the manufacturing process periodically to give the user a sense of ease. Furthermore, if the user is excited, the manufacturing unit can notify the progress of the manufacturing process in a visually attractive format. By notifying the progress of the manufacturing process according to the user's emotion, user satisfaction can be improved. Specifically, the manufacturing unit tokenizes or performs spectral conversion on the user's natural language text received from the receiving unit (e.g., “I'm in a hurry, I want to know the progress immediately”), voice data (e.g., fast speech rate or tone), real-time chat logs, or the user's past emotion history in a preprocessing unit, and inputs them into an emotion estimation AI (e.g., Transformer-based large language model, speech emotion recognition CNN, multimodal fusion network). Examples of input to the AI include: (1) natural language text indicating urgency such as “I want to know the progress immediately”; (2) voice data with fast tone or speech rate; (3) time-series emotion score arrays extracted from chat history. The emotion estimation AI outputs emotion labels (e.g., urgent, relaxed, excited), emotion intensity scores (e.g., 0.91/1.0), and time-series emotion change vectors from the input data. Examples of output include probability distributions such as “urgent: 0.92, relaxed: 0.08”, an “excited” label, and time-series transitions such as “emotion change: urgent→relaxed”. The manufacturing unit inputs these emotion estimation results into a progress notification control AI or user notification module and dynamically adjusts notification frequency (e.g., real-time, periodic, upon process completion), notification format (e.g., text, graph, UI with animation, etc.), and notification content granularity according to the emotional state. For example, if urgency is high, real-time notifications are sent for each process; if relaxation is high, periodic notifications are sent once a day; if excitement is high, colorful progress bars or animated notifications are automatically generated. The manufacturing unit accumulates user reactions and satisfaction as feedback and utilizes them to improve the personalization accuracy of the AI model and notification experience algorithms. As a technical effect, the manufacturing unit can estimate the user's emotional state with high accuracy and in real time, and optimize the progress notification method based on the result, thereby achieving improvements in user experience, provision of reassurance, and reduction of dropout rate compared to conventional uniform notification or manual handling. In addition, emotion estimation in high-dimensional feature space and dynamic notification control by AI enable complex notification optimization that is difficult with human heuristics or simple rule-based approaches. Specific application fields include custom product manufacturing, smart factories, personalized manufacturing lines, manufacturing sites with entertainment features, and future developments may include further automatic optimization of the notification experience through integration with biosensors and real-time emotion feedback.

The delivery unit can estimate the user's emotion and adjust the communication method during delivery based on the estimated emotion of the user. For example, if the user is in a hurry, concise and prompt communication is performed. If the user is relaxed, polite and detailed communication can be provided. Furthermore, if the user is excited, visually appealing messages can be sent. By adjusting the communication method during delivery according to the user's emotion, user satisfaction can be improved. Specifically, the delivery unit tokenizes or performs spectral conversion on the user's natural language text (e.g., “I'm in a hurry, I want to know the progress immediately”), voice data (e.g., fast speech rate or tone), real-time chat logs, or the user's past emotion history received from the receiving unit or user interface in a preprocessing unit, and inputs them into an emotion estimation AI (e.g., Transformer-based large language model, voice emotion recognition CNN, multimodal fusion network). Examples of input to the AI include: (1) natural language text indicating urgency such as “I want it delivered today”; (2) voice data with fast tone or speech rate; (3) time-series emotion score arrays extracted from chat history. The emotion estimation AI outputs emotion labels (e.g., urgent, relaxed, excited), emotion intensity scores (e.g., 0.91/1.0), and time-series emotion change vectors from the input data. Examples of output include probability distributions such as “urgent: 0.92, relaxed: 0.08”, an “excited” label, and time-series transitions such as “emotion change: urgent→relaxed”. The delivery unit inputs these emotion estimation results into a communication control AI or notification generation module, and dynamically adjusts the communication method (e.g., concise notification, detailed explanation, animated message), notification frequency, and expression format according to the emotional state. For example, if the urgency is high, a short notification with only key points is automatically generated; if the relaxation level is high, a detailed progress explanation is provided; if the excitement level is high, a message with colorful effects is generated. The delivery unit accumulates user reactions and satisfaction as feedback, and utilizes them to improve the continuous learning of the AI model and the personalization accuracy of the communication experience algorithm. As a technical effect, the delivery unit can estimate the user's emotional state with high accuracy and in real time, and optimize the communication method based on the result, thereby achieving improvements in user experience, providing a sense of security, and reducing churn rate compared to conventional uniform notifications or manual handling. In addition, emotion estimation in high-dimensional feature space and dynamic notification control by AI enable complex notification optimization that is difficult with human heuristics or simple rule-based approaches. Specific application fields include custom product delivery, smart logistics, personalized delivery lines, and delivery sites with entertainment elements, and future developments may include further automatic optimization of notification experience through integration with biometric sensors and real-time emotion feedback.

The receiving unit can estimate the user's emotion and determine the priority of requests based on the estimated emotion of the user. For example, if the user is feeling stressed, the priority of the request is set high and responded to promptly. If the user is relaxed, the priority of the request can be set as usual. Furthermore, if the user is in a hurry, the request can be set to the highest priority and responded to immediately. By determining the priority of requests according to the user's emotion, prompt and appropriate responses become possible. Specifically, the receiving unit tokenizes or performs spectral conversion on natural language text entered by the user into the chat box, voice data, real-time chat logs, etc., in a preprocessing unit, and inputs them into an emotion estimation AI (e.g., Transformer-based large language model, voice emotion recognition CNN, multimodal fusion network). Examples of input to the AI include: (1) natural language text indicating urgency such as “I want you to respond immediately”; (2) voice data with fast tone or speech rate; (3) time-series emotion score arrays extracted from chat history. The emotion estimation AI outputs emotion labels (e.g., stress, relaxation, urgency), emotion intensity scores (e.g., 0.91/1.0), and time-series emotion change vectors from the input data. Examples of output include probability distributions such as “urgent: 0.92, relaxed: 0.08”, a “stress” label, and time-series transitions such as “emotion change: urgent→relaxed”. The receiving unit inputs these emotion estimation results into a priority determination AI or receiving scheduler, and dynamically adjusts the priority of requests (e.g., immediate execution, normal execution, delayed execution) and receiving timing according to the emotional state. For example, if the urgency is high, the request is processed with the highest priority; if the relaxation level is high, the process proceeds with normal priority; if the stress level is high, additional questions are omitted and immediate response is provided. The receiving unit accumulates user reactions and satisfaction as feedback, and utilizes them to improve the continuous learning of the AI model and the personalization accuracy of the priority determination algorithm. As a technical effect, the receiving unit can estimate the user's emotional state with high accuracy and in real time, and optimize the request priority based on the result, thereby achieving improvements in user experience, speeding up receiving processing, and reducing churn rate compared to conventional uniform receiving or manual handling. In addition, emotion estimation in high-dimensional feature space and dynamic priority control by AI enable complex receiving optimization that is difficult with human heuristics or simple rule-based approaches. Specific application fields include custom product order receiving, automatic response in call centers, stress care-type receiving in medical and welfare fields, and smart home appliance control interfaces, and future developments may include integration with biometric sensors and real-time emotion feedback.

The generation unit can adjust the specific level of detail of the design drawing at the time of generating the design drawing based on the importance of the product. For example, for products of high importance, a detailed design drawing is generated to support precise manufacturing. For products of low importance, a concise design drawing can be generated to support rapid manufacturing. Furthermore, the generation unit can also adjust the level of detail of the design drawing stepwise according to the importance of the product. By adjusting the level of detail of the design drawing according to the importance of the product, the efficiency of the manufacturing process can be improved. Specifically, the generation unit receives a product specification vector (e.g., a multidimensional vector including dimensions, material, category, importance score, etc.) from the receiving unit as input, and assigns an importance score (e.g., a continuous value such as 0.95/1.0 or a categorical value such as “high”, “medium”, “low”) to the design drawing generation AI. The generation unit uses a Transformer-based large language model, conditional generation network, or multimodal neural network to automatically determine design drawing generation parameters (e.g., level of detail, amount of annotation, dimensional accuracy, degree of component breakdown, etc.) by combining the input vector and importance score. Examples of input to the AI include: (1) a vector of dimensions, material, category, and importance=high; (2) a simplified product specification vector with importance=low; (3) a product specification vector with an intermediate importance score of 0.7. Examples of AI output include: (1) a JSON design specification including detailed dimensions, materials, and assembly procedures (high importance); (2) a simplified design drawing listing only main dimensions and parts list (low importance); (3) annotated 3D CAD data with moderate detail (medium importance). The generation unit dynamically adjusts the granularity and amount of annotation of the design drawing data transferred to the manufacturing unit according to the level of detail parameter output by the AI. In subsequent processing, the manufacturing unit switches the control command generation algorithm for NC machine tools or industrial robots according to the level of detail of the received design drawing, optimizing processes such as precision machining or simple assembly. As a technical effect, the generation unit can automatically adjust the level of detail of the design drawing according to the importance of the product, thereby achieving efficiency in the design and manufacturing process, optimal resource allocation, reduction of manufacturing costs, and shortening of delivery times compared to conventional uniform design drawing generation or manual adjustment of detail level. In addition, optimization of detail level in high-dimensional feature space by AI enables complex design drawing generation control that is difficult with human heuristics or simple rule-based approaches. Specific application fields include precision manufacturing of important components, simple mass production of consumables, stepwise design support for custom products, and automatic optimization of B2B/B2C manufacturing lines, and future developments may include IoT integration and design drawing granularity control across the entire supply chain.

Below, the processing flow of Example of the Embodiment is briefly described. Specifically, the present system operates in cooperation among the receiving unit, generation unit, manufacturing unit, and delivery unit, automating the entire process from receiving the user's request to product design, manufacturing, and delivery. The receiving unit receives user input data (natural language text, voice data, image data, etc.), performs tokenization and feature extraction in a preprocessing unit, and inputs them into an emotion estimation AI or history analysis AI. Examples of input to the AI include natural language text such as “I want to order a shelf in the furniture category” or “I'm in a hurry, please deliver quickly”, voice data, and vectors of past purchase/request history. The receiving unit automatically displays the optimal receiving method and product candidates on the user interface based on the AI output (e.g., emotion label, recommended product candidates, receiving priority, etc.). The generation unit inputs the request content received from the receiving unit, user attributes, past feedback, emotion estimation results, etc., into a design drawing generation AI (e.g., Transformer-based large language model, multimodal generation model, etc.) and generates product specification vectors and design drawing data (e.g., JSON design specification, 3D CAD data, etc.). Examples of AI output include design drawings containing detailed dimensions, materials, and assembly procedures, and personalized design drawings with colorful color schemes. The manufacturing unit controls manufacturing devices such as NC machine tools, industrial robots, and 3D printers based on the design drawing data received from the generation unit, and automates the manufacturing process using real-time quality monitoring AI and process optimization AI. The manufacturing unit inputs sensor data (dimensions, images, torque, etc.) into the quality monitoring AI to perform anomaly detection and process parameter adjustment. The delivery unit, after manufacturing is completed, inputs delivery requests, geographic location information, emotion estimation results of the user, etc., into a delivery scheduling AI or route optimization AI to determine the optimal delivery means, schedule, and notification method for delivering the product to the address specified by the user. The delivery unit dynamically adjusts progress notifications and delivery experience elements (special messages, gift inclusion, etc.) to optimize the user experience. As a technical effect, the present system realizes high-dimensional feature space analysis and dynamic optimization by AI in each process, greatly improving overall processing efficiency, personalization accuracy, user satisfaction, and business automation level compared to conventional manual work or static systems. Specific application fields include custom product design, manufacturing, and delivery platforms, smart factories, personalized e-commerce, individualized services in medical and welfare fields, and IoT-linked supply chain optimization, and future developments can easily include new AI technologies, addition of external data sources, multi-site cooperation, and real-time optimization.

Step 1: The receiving unit receives a request input by the user into a chat box. The user's request includes the type, specifications, and quantity of the product. The receiving unit can receive requests in the form of text input, voice input, or real-time response. Step 2: The generation unit uses generative AI to create a product design drawing based on the request received by the receiving unit. The generative AI uses technologies such as deep learning and neural networks to specifically design the dimensions, materials, and structure of the product based on the user's request. Step 3: The manufacturing unit automatically performs processes of cutting materials, assembling, and finishing based on the design drawing created by the generative AI. The manufacturing unit automates the manufacturing process according to the machines used, work procedures, and quality standards. Step 4: The delivery unit delivers the manufactured product to an address specified by the user. The delivery unit uses means such as courier service, mail, or drone delivery to deliver the product to the address specified by the user. Specifically, in Step 1, the receiving unit receives various input formats such as natural language text entered by the user into a chat box (e.g., “I want to order a shelf in the furniture category”), voice data (e.g., “I'm in a hurry, please deliver quickly”), and image data (e.g., uploading reference images), performs preprocessing such as tokenization, speech recognition, and image feature extraction in a preprocessing unit, and inputs them into an emotion estimation AI or history analysis AI. Examples of input to the AI include natural language text such as “I want to order a shelf in the furniture category”, voice data such as “I'm in a hurry, please deliver quickly”, and vectors of past purchase/request history. The receiving unit automatically displays the optimal receiving method and product candidates on the user interface based on the AI output (e.g., emotion label, recommended product candidates, receiving priority, etc.). In Step 2, the generation unit inputs the request content received from the receiving unit, user attributes, past feedback, emotion estimation results, etc., into a design drawing generation AI (e.g., Transformer-based large language model, multimodal generation model, etc.) and generates product specification vectors and design drawing data (e.g., JSON design specification, 3D CAD data, etc.). Examples of AI output include design drawings containing detailed dimensions, materials, and assembly procedures, and personalized design drawings with colorful color schemes. In Step 3, the manufacturing unit controls manufacturing devices such as NC machine tools, industrial robots, and 3D printers based on the design drawing data received from the generation unit, and automates the manufacturing process using real-time quality monitoring AI and process optimization AI. The manufacturing unit inputs sensor data (dimensions, images, torque, etc.) into the quality monitoring AI to perform anomaly detection and process parameter adjustment. In Step 4, the delivery unit, after manufacturing is completed, inputs delivery requests, geographic location information, emotion estimation results of the user, etc., into a delivery scheduling AI or route optimization AI to determine the optimal delivery means, schedule, and notification method for delivering the product to the address specified by the user. The delivery unit dynamically adjusts progress notifications and delivery experience elements (special messages, gift inclusion, etc.) to optimize the user experience. As a technical effect, the present system realizes high-dimensional feature space analysis and dynamic optimization by AI in each process, greatly improving overall processing efficiency, personalization accuracy, user satisfaction, and business automation level compared to conventional manual work or static systems. Specific application fields include custom product design, manufacturing, and delivery platforms, smart factories, personalized e-commerce, individualized services in medical and welfare fields, and IoT-linked supply chain optimization, and future developments can easily include new AI technologies, addition of external data sources, multi-site cooperation, and real-time optimization.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the plurality of elements including the aforementioned receiving unit, generation unit, manufacturing unit, and delivery unit is implemented, for example, by at least one of a smart device 14 and a data processing apparatus 12. For example, the receiving unit is implemented by a control unit 46A of the smart device 14 and receives a request input by the user into a chat box. The generation unit is implemented, for example, by a specific processing unit 290 of the data processing apparatus 12 and creates a product design drawing using generative AI. The manufacturing unit is implemented, for example, by the specific processing unit 290 of the data processing apparatus 12 and manufactures a product based on the design drawing created by generative AI. The delivery unit is implemented, for example, by the control unit 46A of the smart device 14 and delivers the manufactured product to an address specified by the user. The correspondence between each unit and the device or control unit is not limited to the examples described above and various modifications are possible.

### Second Embodiment

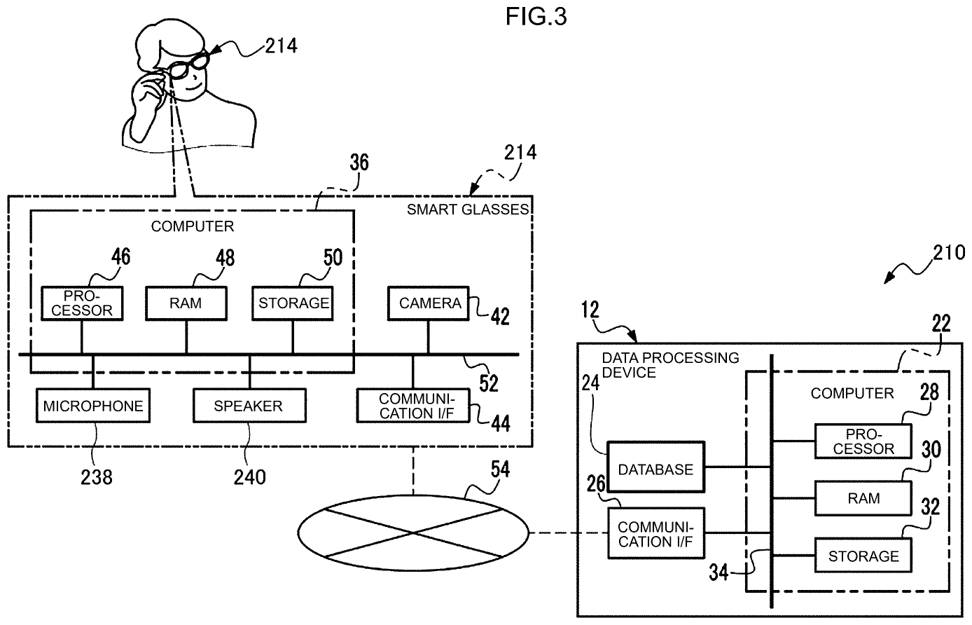

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

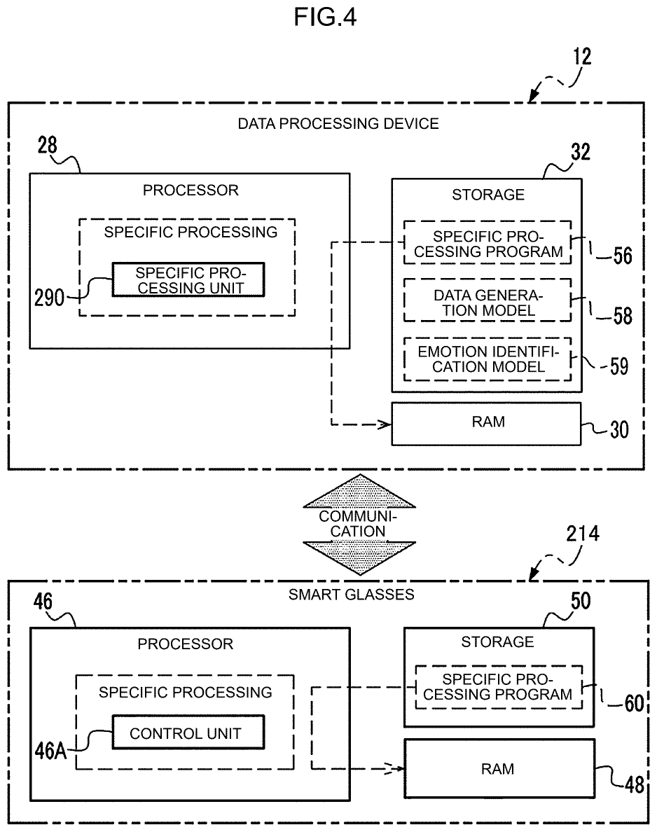

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the plurality of elements including the aforementioned receiving unit, generation unit, manufacturing unit, and delivery unit is implemented, for example, by at least one of smart glasses 214 and a data processing apparatus 12. For example, the receiving unit is implemented by a control unit 46A of the smart glasses 214 and receives a request input by the user into a chat box. The generation unit is implemented, for example, by a specific processing unit 290 of the data processing apparatus 12 and creates a product design drawing using generative AI. The manufacturing unit is implemented, for example, by the specific processing unit 290 of the data processing apparatus 12 and manufactures a product based on the design drawing created by generative AI. The delivery unit is implemented, for example, by the control unit 46A of the smart glasses 214 and delivers the manufactured product to an address specified by the user. The correspondence between each unit and the device or control unit is not limited to the examples described above and various modifications are possible.

### Third Embodiment

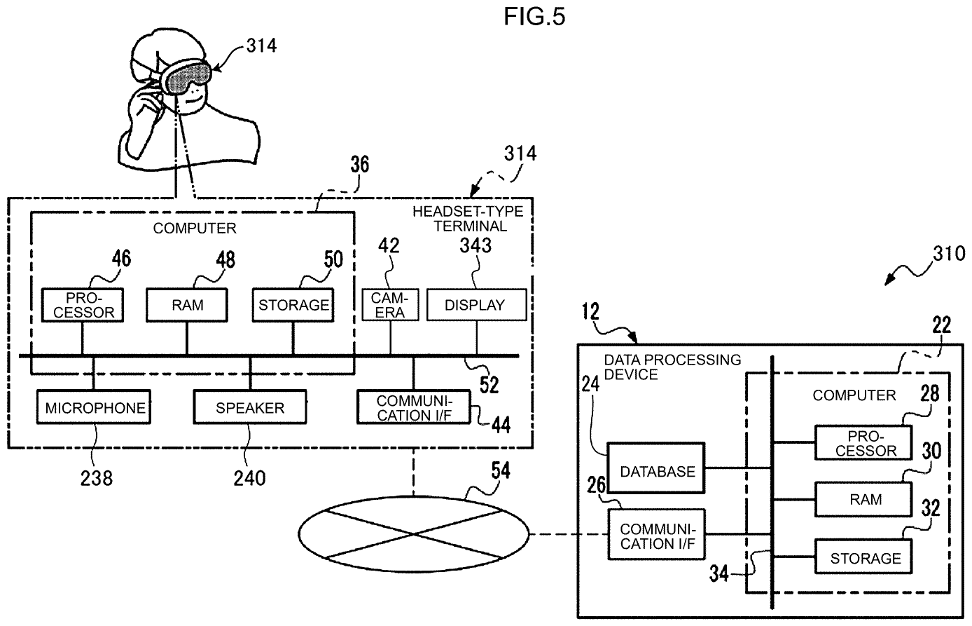

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

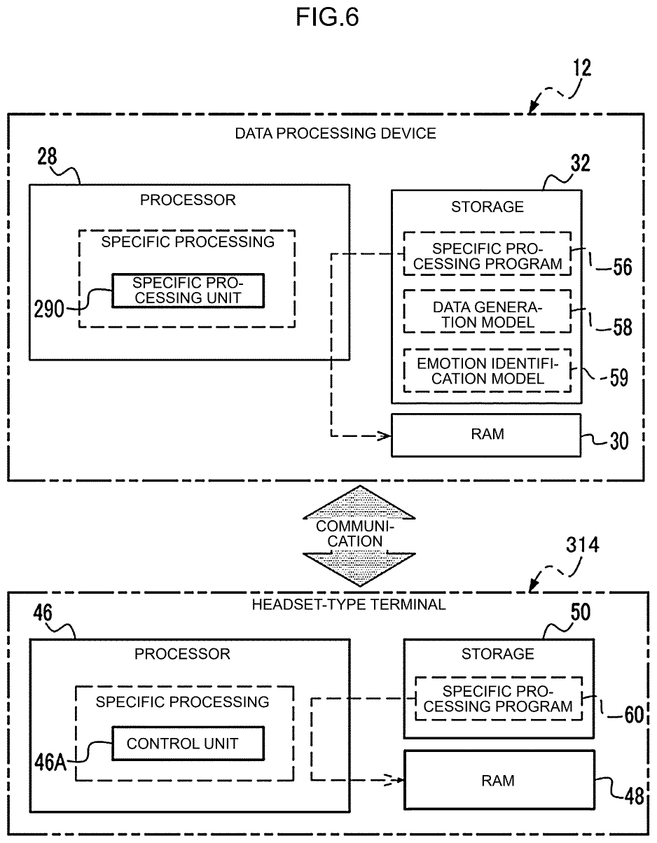

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of the plurality of elements including the aforementioned receiving unit, generation unit, manufacturing unit, and delivery unit is implemented, for example, by at least one of a headset-type terminal 314 and a data processing apparatus 12. For example, the receiving unit is implemented by a control unit 46A of the headset-type terminal 314 and receives a request input by the user into a chat box. The generation unit is implemented, for example, by a specific processing unit 290 of the data processing apparatus 12 and creates a product design drawing using generative AI. The manufacturing unit is implemented, for example, by the specific processing unit 290 of the data processing apparatus 12 and manufactures a product based on the design drawing created by generative AI. The delivery unit is implemented, for example, by the control unit 46A of the headset-type terminal 314 and delivers the manufactured product to an address specified by the user. The correspondence between each unit and the device or control unit is not limited to the examples described above and various modifications are possible.

### Fourth Embodiment

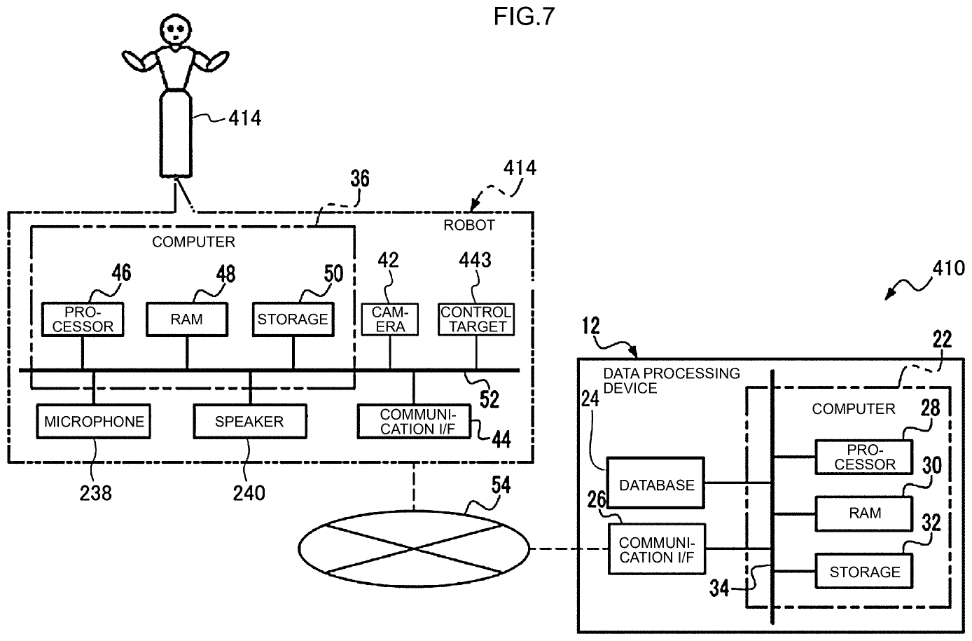

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

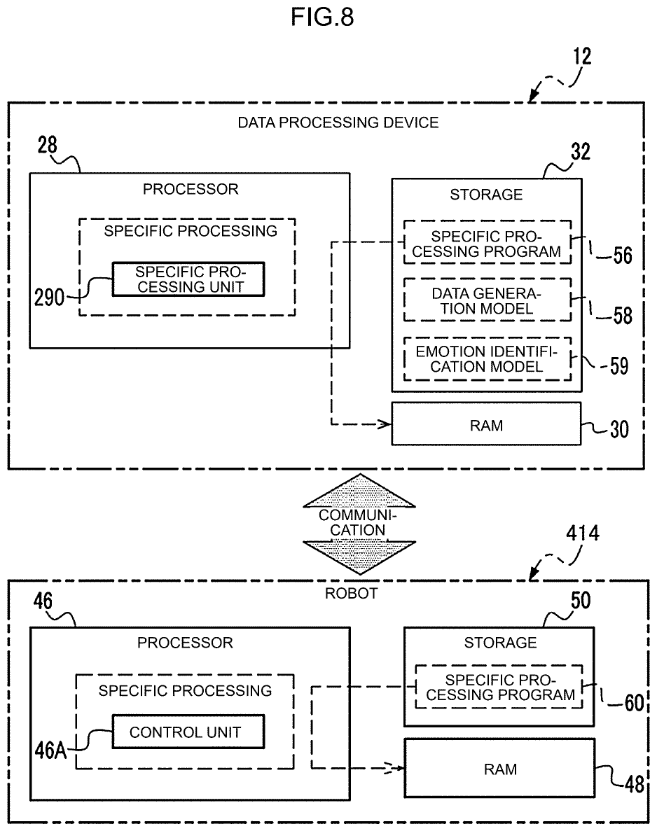

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the plurality of elements including the aforementioned receiving unit, generation unit, manufacturing unit, and delivery unit is implemented, for example, by at least one of a robot 414 and a data processing apparatus 12. For example, the receiving unit is implemented by a control unit 46A of the robot 414 and receives a request input by the user into a chat box. The generation unit is implemented, for example, by a specific processing unit 290 of the data processing apparatus 12 and creates a product design drawing using generative AI. The manufacturing unit is implemented, for example, by the specific processing unit 290 of the data processing apparatus 12 and manufactures a product based on the design drawing created by generative AI. The delivery unit is implemented, for example, by the control unit 46A of the robot 414 and delivers the manufactured product to an address specified by the user. The correspondence between each unit and the device or control unit is not limited to the examples described above and various modifications are possible.

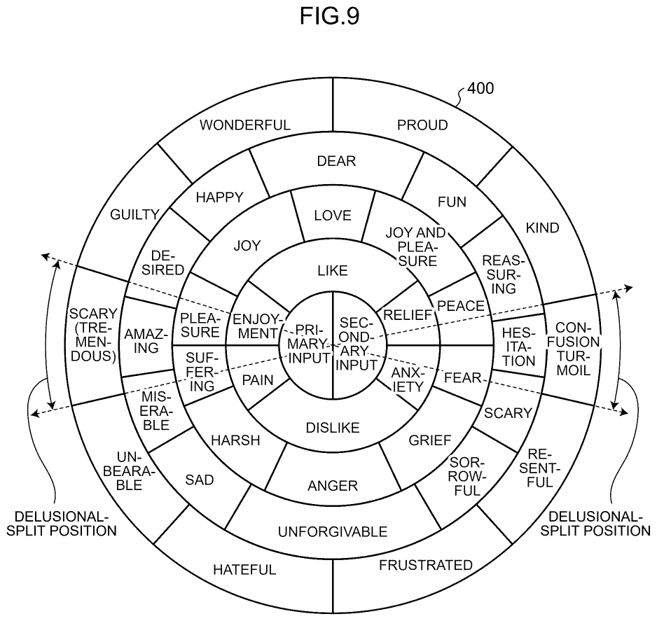

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

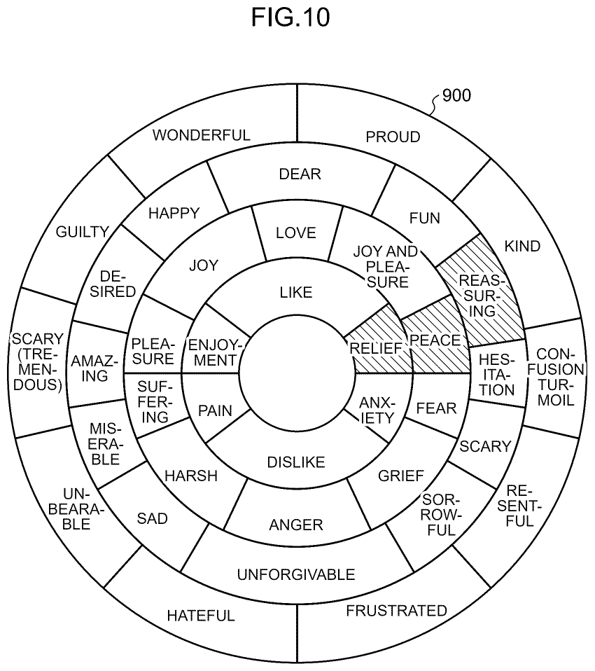

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

(Supplementary Note 1) A system comprising: a receiving unit configured to receive a user's request; a generation unit configured to create a product design drawing based on the request received by the receiving unit; a manufacturing unit configured to manufacture a product based on the design drawing created by the generation unit; and a delivery unit configured to deliver the product manufactured by the manufacturing unit to an address specified by the user.

(Supplementary Note 2) The system according to Supplementary Note 1, wherein the receiving unit is configured to receive a request input by the user into a chat box.

(Supplementary Note 3) The system according to Supplementary Note 1, wherein the generation unit is configured to specifically design the dimensions, materials, and structure of the product based on the user's request by using generative AI.

(Supplementary Note 4) The system according to Supplementary Note 1, wherein the manufacturing unit is configured to automatically perform processes of cutting materials, assembling, and finishing based on the design drawing created by generative AI.

(Supplementary Note 5) The system according to Supplementary Note 1, wherein the delivery unit is configured to deliver the manufactured product to an address specified by the user.

(Supplementary Note 6) The system according to Supplementary Note 1, wherein the receiving unit is configured to estimate the user's emotion and adjust the timing of receiving the request based on the estimated emotion of the user.

(Supplementary Note 7) The system according to Supplementary Note 1, wherein the receiving unit is configured to analyze the user's past request history and select an appropriate receiving method.

(Supplementary Note 8) The system according to Supplementary Note 1, wherein the receiving unit is configured to perform filtering at the time of receiving a request based on the user's current project or field of interest.

(Supplementary Note 9) The system according to Supplementary Note 1, wherein the receiving unit is configured to estimate the user's emotion and determine the priority of requests to be received based on the estimated emotion of the user.

(Supplementary Note 10) The system according to Supplementary Note 1, wherein the receiving unit is configured to preferentially receive highly relevant requests by considering the user's geographic location information at the time of receiving a request.

(Supplementary Note 11) The system according to Supplementary Note 1, wherein the receiving unit is configured to analyze the user's social media activity at the time of receiving a request and receive relevant requests.

(Supplementary Note 12) The system according to Supplementary Note 1, wherein the generation unit is configured to estimate the user's emotion and adjust the expression method of the design drawing based on the estimated emotion of the user.

(Supplementary Note 13) The system according to Supplementary Note 1, wherein the generation unit is configured to adjust the specific level of detail of the design drawing at the time of generating the design drawing based on the importance of the product.

(Supplementary Note 14) The system according to Supplementary Note 1, wherein the generation unit is configured to apply an appropriate design algorithm at the time of generating the design drawing according to the category of the product.

(Supplementary Note 15) The system according to Supplementary Note 1, wherein the generation unit is configured to estimate the user's emotion and adjust the length of the design drawing based on the estimated emotion of the user.

(Supplementary Note 16) The system according to Supplementary Note 1, wherein the generation unit is configured to determine the specific priority of the design drawing at the time of generating the design drawing based on the submission timing of the product.

(Supplementary Note 17) The system according to Supplementary Note 1, wherein the generation unit is configured to adjust the specific order of the design drawing at the time of generating the design drawing based on the relevance of the product.

(Supplementary Note 18) The system according to Supplementary Note 1, wherein the manufacturing unit is configured to estimate the user's emotion and adjust the method of the manufacturing process based on the estimated emotion of the user.

(Supplementary Note 19) The system according to Supplementary Note 1, wherein the manufacturing unit is configured to estimate the user's emotion and adjust the method of the manufacturing process based on the estimated emotion of the user.

(Supplementary Note 20) The system according to Supplementary Note 1, wherein the manufacturing unit is configured to analyze the user's past product manufacturing history at the time of manufacturing and select an appropriate manufacturing method.

(Supplementary Note 21) The system according to Supplementary Note 1, wherein the manufacturing unit is configured to specifically customize the manufacturing process at the time of manufacturing based on the user's current living situation.

(Supplementary Note 22) The system according to Supplementary Note 1, wherein the manufacturing unit is configured to estimate the user's emotion and determine the priority of the manufacturing process based on the estimated emotion of the user.

(Supplementary Note 23) The system according to Supplementary Note 1, wherein the manufacturing unit is configured to select an appropriate manufacturing method at the time of manufacturing by considering the user's geographic location information.

(Supplementary Note 24) The system according to Supplementary Note 1, wherein the manufacturing unit is configured to analyze the user's social media activity at the time of manufacturing and specifically propose the manufacturing process.

(Supplementary Note 25) The system according to Supplementary Note 1, wherein the delivery unit is configured to estimate the user's emotion and adjust the delivery method based on the estimated emotion of the user.

(Supplementary Note 26) The system according to Supplementary Note 1, wherein the delivery unit is configured to analyze the user's past delivery history at the time of delivery and select an appropriate delivery method.

(Supplementary Note 27) The system according to Supplementary Note 1, wherein the delivery unit is configured to specifically customize the delivery means at the time of delivery based on the user's current living situation.

(Supplementary Note 28) The system according to Supplementary Note 1, wherein the delivery unit is configured to estimate the user's emotion and determine the priority of delivery based on the estimated emotion of the user.

(Supplementary Note 29) The system according to Supplementary Note 1, wherein the delivery unit is configured to select an appropriate delivery method at the time of delivery by considering the user's geographic location information.

(Supplementary Note 30) The system according to Supplementary Note 1, wherein the delivery unit is configured to analyze the user's social media activity at the time of delivery and specifically propose the delivery means.

What is claimed is:

1. A system comprising:
a communication interface configured to communicate with a client terminal via a network;
a memory storing a data generation model obtained by deep learning on a neural network; and
circuitry configured to:
receive, from the client terminal via the communication interface, request data indicating a product specification input by a user;
convert the request data into a product specification vector by applying named entity extraction to the request data;
generate, by inputting the product specification vector into the data generation model, design drawing data comprising at least one of a design specification document, three-dimensional computer-aided design data, or assembly instructions for a product corresponding to the product specification vector;
generate a sequence of control commands for at least one of a numerically controlled machine tool or an industrial robot based on the design drawing data; and
acquire sensor data during execution of the sequence of control commands and determine, based on the sensor data, a quality judgment for the product.

2. The system according to claim 1,
wherein the circuitry is further configured to receive the request data from a chat interface of the client terminal.

3. The system according to claim 1,
wherein the circuitry is further configured to determine, based on a delivery address indicated in the request data, a delivery route for delivering the product manufactured according to the sequence of control commands.

4. The system according to claim 1,
wherein the design drawing data comprises a design specification document in a structured data format describing dimensions, materials, and structure of the product.

5. The system according to claim 1,
wherein the sequence of control commands comprises at least one of G-code for a numerically controlled machine tool or an operation sequence for a robot arm.

6. The system according to claim 1,
wherein the circuitry is further configured to automatically adjust a process parameter of the at least one of the numerically controlled machine tool or the industrial robot based on the quality judgment.

7. The system according to claim 1,
wherein the sensor data comprises data from at least one of a dimension sensor, an image sensor, or a torque sensor.

8. The system according to claim 1,
wherein the named entity extraction is performed by a model based on bidirectional encoder representations from transformers.

9. The system according to claim 1,
wherein the circuitry is further configured to convert voice data received from the client terminal into text data using a speech recognition engine prior to applying the named entity extraction.

10. The system according to claim 1,
wherein the circuitry is further configured to estimate an emotion of the user by inputting the request data into an emotion identification model stored in the memory, and adjust a timing of processing the request data based on the estimated emotion.

11. The system according to claim 1,
wherein the circuitry is further configured to select a design algorithm from a plurality of design algorithm modules based on a product category indicated in the product specification vector, and generate the design drawing data using the selected design algorithm.

12. The system according to claim 1,
wherein the circuitry is further configured to determine a level of detail for the design drawing data based on an importance score assigned to the product, and generate the design drawing data at the determined level of detail.

13. The system according to claim 1,
wherein the circuitry is further configured to analyze a past request history associated with the user and select a receiving method for the request data based on the past request history.

14. The system according to claim 1,
wherein the circuitry is further configured to filter the request data based on a current project or field of interest associated with the user, and preferentially process request data having a relevance score above a threshold.

15. The system according to claim 1,
wherein the circuitry is further configured to analyze a past product manufacturing history associated with the user and select a manufacturing method for generating the sequence of control commands based on the past product manufacturing history.

16. The system according to claim 1,
wherein the circuitry is further configured to determine a priority for generating the design drawing data based on a submission timing associated with the product.

17. The system according to claim 1,
wherein the circuitry is further configured to estimate an emotion of the user and adjust a notification frequency and a notification format for progress of execution of the sequence of control commands based on the estimated emotion.

18. A system comprising:
a communication interface configured to communicate with a client terminal via a packet-switched network;
a memory storing a data generation model and an emotion identification model, each obtained by deep learning on a neural network; and
circuitry configured to:
receive, from the client terminal via the communication interface, request data comprising natural language text indicating a product specification input by a user;
convert the request data into a product specification vector by performing morphological analysis and named entity extraction on the natural language text;
estimate an emotion of the user by inputting the request data into the emotion identification model;
generate, by inputting the product specification vector into the data generation model, design drawing data comprising a design specification document in a structured data format and three-dimensional computer-aided design data for a product corresponding to the product specification vector;
generate a sequence of control commands comprising at least one of G-code for a numerically controlled machine tool or an operation sequence for a robot arm based on the design drawing data;
acquire sensor data from at least one of a dimension sensor, an image sensor, or a torque sensor during execution of the sequence of control commands and determine, based on the sensor data, a quality judgment score for the product; and
transmit, to the client terminal via the communication interface, a progress notification indicating a status of manufacturing of the product, wherein a frequency of the progress notification is adjusted based on the estimated emotion of the user.

19. The system according to claim 18,
wherein the data generation model comprises at least one of a text generation AI, an image generation AI, or a multimodal generation AI, and
wherein the data generation model is a fine-tuned model configured to output inference results from prompts without instructions.

20. A method performed by a system comprising a communication interface, a memory storing a data generation model obtained by deep learning on a neural network, and circuitry, the method comprising:
receiving, from a client terminal via the communication interface, request data indicating a product specification input by a user;
converting the request data into a product specification vector by applying named entity extraction to the request data;
generating, by inputting the product specification vector into the data generation model, design drawing data comprising at least one of a design specification document, three-dimensional computer-aided design data, or assembly instructions for a product corresponding to the product specification vector;
generating a sequence of control commands for at least one of a numerically controlled machine tool or an industrial robot based on the design drawing data; and
acquiring sensor data during execution of the sequence of control commands and determining, based on the sensor data, a quality judgment for the product.
